(19) United States
(12) Patent Application Publication
(10) Pub. No.: US 2024/0295292 A1
(43) Pub. Date: Sep. 5, 2024

(54) METHOD OF AND APPARATUS FOR TRANSFERING GAS

(71) Applicant: NANOSUN IP LIMITED, Lancaster, Lancashire (GB)

(72) Inventors: Paul Joseph HODGSON, Cambridge (GB); Faisal Adil SHAIKH, Lancaster (GB); Mohammad SAGHAFIFAR, Lancaster (GB)

(21) Appl. No.: 18/554,915

(22) PCT Filed: Apr. 12, 2022
(86) PCT No.: PCT/GB2022/050917

§ 371 Date: Oct. 11, 2023

(30) Foreign Application Priority Data
Apr. 12, 2021 (GB) 2105161.0

(51) Int. Cl. F17C 5/06; F17C 5/00

(52) U.S. Cl. CPC F17C 5/06; F17C 5/007; F17C 2201/0138; F17C 2201/056; F17C 2203/03; F17C 2205/0138; F17C 2205/0323; F17C 2221/012; F17C 2221/014; F17C 2221/016; F17C 2221/033; F17C 2223/0123; F17C 2223/036; F17C 2225/0123; F17C 2225/036; F17C 2227/0192; F17C 2227/0344; F17C 2227/036; F17C 2227/047; F17C 2250/0631; F17C 2265/061; F17C 2265/065; F17C 2270/0176

(57) ABSTRACT

A method of and apparatus for transferring gas. The method comprising expanding a process gas 101 having a first temperature to produce a first volume of the process gas that has a second temperature that is greater than the first temperature, and a second volume of the process gas that has a third temperature that is less than the first temperature. The method further comprises displacing at least some of the second volume of the process gas 102 into the receiving vessel using a piston gas, wherein the piston gas is of the same type as the process gas.

### BACKGROUND

When hydrogen powered vehicles or machines are refueled, hydrogen gas is transferred from a high-pressure storage vessel to a receiving vessel or a vessel in the vehicle or machine. The addition of the gas into the receiving vessel compresses the gas in the receiving vessel leading to an increase in temperature. For fast refueling, the fast addition of gas to the receiving vessel leads to rapid compression of the gas in the receiving vessel causing high gas temperatures in that vessel because there is insufficient time for the heat generated during the compression to dissipate through the vessel walls. High temperatures of the gas in the receiving vessel can lead to a weakening or damage in the receiving vessel wall. Thus, the lifetime of the receiving vessel is reduced by high gas temperatures in the receiving vessel. For example, if the receiving vessel is a light-weight composite cylinder, such cylinders can be damaged if the temperature of the gas within the cylinder exceeds 85° C. Additionally, over time, the high temperature of the gas in the receiving vessel will reduce until it reaches an equilibrium state with the cooler temperature of the ambient surroundings. Thus, the gas pressure in the receiving vessel is reduced and hence the mass of gas stored in the receiving vessel is lower than its maximum capacity.

To avoid high gas temperatures in the receiving vessel, the rate of gas addition into the vessel may be limited. This may be achieved by filling the receiving vessel in stages, by adding an amount of gas to the receiving vessel then waiting for the heat generated from the gas transfer to dissipate through the vessel wall and from the vessel exterior surface through conduction, convection or radiation. Once the heat has sufficiently dissipated more gas can be added to the receiving vessel. This process leads to a slow rate of refueling.

Alternatively, the hydrogen gas may be cooled prior to being transferred to the receiving vessel. Typically, the gas may be cooled to between 0° C. and −40° C. prior to transfer into the receiving vessel. This allows for fast refueling of hydrogen powered vehicles or machines. A refrigeration cycle may be used to cool the hydrogen through a heat exchanger. However, chilling hydrogen in this way is energy-intensive given the high specific heat capacity of hydrogen of 14.3 kJ/kgK. Such problems are not unique to hydrogen gas and may also be associated with other compressed gases.

It is an object of embodiments of the invention to at least mitigate one or more of the problems of the prior art. In particular, the invention provides a method and apparatus for improving the cooling of a gas during transfer to a receiving vessel.

### BRIEF SUMMARY OF THE DISCLOSURE

According to a first aspect of the invention, there is provided a method of transferring gas. The method comprises:
expanding a process gas having a first temperature to produce a first volume of the process gas that has a second temperature that is greater than the first temperature, and a second volume of the process gas that has a third temperature that is less than the first temperature; and
displacing at least some of the second volume of the process gas into a receiving vessel using a piston gas, wherein the piston gas is of the same type as the process gas.

In certain embodiments, expanding the process gas may comprise expanding a portion of the process gas into the receiving vessel to produce the first volume residing in the receiving vessel.

The method may comprise expanding a first gas having a fourth temperature that is greater than the first temperature to produce a first volume of the first gas and a second volume of the first gas that has the first temperature, wherein process gas comprises the first volume of the first gas.

The method may comprise storing the second volume of the process gas in a vessel prior to displacing at least some of the second volume of the process gas into the receiving vessel using the piston gas, wherein the vessel is thermally insulated from a surrounding environment or the vessel is thermally insulated from the second volume of the process gas.

In certain embodiments, the second volume of the process gas may have substantially the same pressure as the receiving vessel.

The method may comprise providing the process gas by displacing a first gas wherein the first gas and the process gas are at substantially the same pressure.

In certain embodiments, at least some of the first volume of the process gas may be cooled prior to it residing in the receiving vessel or a vessel. The method may comprise using a heat exchanger to cool the at least some of the first volume of the process gas prior to it residing in the receiving vessel or the vessel.

In certain embodiments, displacing the at least some of the second volume of the process gas into the receiving vessel using the piston gas may comprise using the piston gas to cause the at least some of the second volume of the process gas to substantially flow according to a plug flow regime into the receiving vessel thereby minimising axial transfer of heat between the first and second volumes of process gas.

A series of elongate members may be provided along which the at least some of the second volume of the process gas is caused to flow such that radial flow is inhibited.

A float may be provided in the series of elongate members between the process gas and the piston gas.

The series of elongate members may comprise a bundle of elongate members. The series elongate members may comprise a series of elongate members that tessellate with one another.

The process gas and the piston gas may each be a compressed gas. The compressed gas may comprise one of oxygen, nitrogen, argon, helium, hydrogen, compressed natural gas, methane and mixtures thereof.

According to a second aspect of the invention, there is provided an apparatus for transferring gas to a receiving vessel. The apparatus comprises:
an auxiliary vessel for containing an auxiliary gas;
a first vessel; and
a second vessel selectively fluidly connectable to the first vessel; and;
wherein the first vessel comprises an opening selectively fluidly connectable to a receiving vessel;
wherein the first vessel is selectively fluidly connectable to the auxiliary vessel such that the auxiliary gas may flow from the auxiliary vessel into the first vessel without passing through the second vessel.

In certain embodiments, the first vessel may be configured to be thermally insulated from a surrounding environment or from a volume of gas within the first vessel.

The second vessel may be thermally coupled to a heat exchanger that is arranged to remove heat from a volume of gas when the volume of gas is contained in the second vessel.

The second vessel may be selectively fluidly connectable to the auxiliary vessel such that the auxiliary gas may flow from the auxiliary vessel into the second vessel without passing through the first vessel and wherein the second vessel comprises an opening selectively fluidly connectable to a receiving vessel.

The apparatus may comprise a heat exchanger in a fluid path connecting the first and second vessels. The heat exchanger may be configured to cool to gas to ambient air temperature.

The apparatus may comprise a third vessel and a fourth vessel; wherein the third vessel and the fourth vessel each comprise an opening selectively fluidly connectable to the receiving vessel; wherein the first, second, third and fourth vessels are each selectively fluidly connectable to the auxiliary vessel such that the auxiliary gas may flow from the auxiliary vessel into each of the vessel without passing through another vessel; and wherein the first and fourth vessels, the second and third vessels and the third and fourth vessels are selectively fluidly connectable coupled to each other

The apparatus may comprise at least one heat exchanger arranged to remove heat from a volume of gas flowing between at least two of the first, the second, the third and the fourth vessels.

The at least one heat exchanger may be configured to cool the volume of gas to ambient air temperature.

The apparatus may comprise a first series of elongate members within the first vessel.

The apparatus may comprise a second series of elongate members within the second vessel.

The apparatus may comprise a first series of elongate members within the first vessel, a second series of elongate members within the second vessel, a third series of elongate members within the third vessel and a fourth series of elongate members within the fourth vessel.

The apparatus may comprise a float movable within each series of elongate members.

Each series of elongate members may comprise a bundle of elongate members. Each series elongate members may comprise a series of elongate members that tessellate with one another.

### BRIEF DESCRIPTION OF THE DRAWINGS

Embodiments of the invention are further described hereinafter with reference to the accompanying drawings, in which:

FIG. 1 shows a method of transferring a gas according to an embodiment of the invention;

FIG. 2 schematically shows an apparatus for implementing the method of FIG. 1;

FIG. 3 shows a method of transferring a gas according to a further embodiment of the invention;

FIG. 4 schematically shows an apparatus according to an embodiment of the invention for implementing the method of FIG. 3;

FIG. 5 shows a method of transferring a gas according to a further embodiment of the invention;

FIG. 6 schematically shows an apparatus according to an embodiment of the invention for implementing the method of FIG. 5;

FIG. 7 shows a method of transferring a gas according to a further embodiment of the invention;

FIG. 8 schematically shows an apparatus according to an embodiment of the invention for implementing the method of FIG. 7;

FIGS. 9 to 12 show an example of transferring gas using the apparatus of FIG. 8 and FIG. 13 shows a comparative example;

FIG. 14 schematically shows an apparatus according to a further embodiment of the invention; and

FIG. 15 shows a method of transferring a gas according to a further embodiment of the invention.

### DETAILED DESCRIPTION

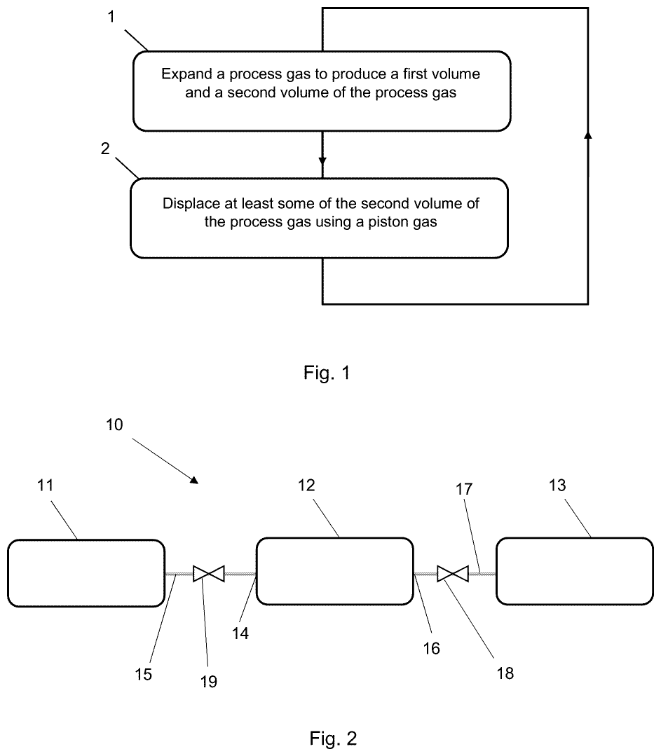

FIG. 1 shows a method for transferring a gas according to an embodiment of the invention and FIG. 2 shows an example of an apparatus 10 for use in the method of FIG. 1.

The apparatus 10 comprises an auxiliary vessel 11, an intermediate vessel 12 and a receiving vessel 13. Each vessel 11, 12, 13 is configured to receive and store gas. The intermediate vessel 12 comprises an inlet or first opening 14. The auxiliary vessel 11 is selectively fluidly connectable to the inlet 14 of the intermediate vessel 12 such that a fluid path 15 selectively connects the auxiliary vessel 11 and the intermediate vessel 12. The intermediate vessel 12 comprises an outlet or second opening 16. The outlet 16 is selectively fluidly connectable to the receiving vessel 13 such that a fluid path 17 selectively connects the intermediate vessel 12 and the receiving vessel 13. The apparatus 10 may comprise values 18, 19 for controlling gas flow along the fluid path 15 connecting the auxiliary and intermediate vessels 11, 12 and the fluid path 17 connecting the intermediate and receiving vessels 12, 13. The valves 18, 19 may comprise needle valves or any other valve capable of controlling the flow of gas along a fluid path. The apparatus 10 may be configured so that each of the auxiliary vessel 11 and the receiving vessel 13 can be disconnected from the intermediate vessel 12. Thus, during use, the auxiliary vessel 11 and/or the receiving vessel 13 are replaceable in the apparatus 10. The auxiliary vessel 11 may be a high-pressure storage vessel having a large volume compared to the intermediate vessel 12. The receiving vessel 13 may have a larger volume that the intermediate vessel 12. The receiving vessel 13 may comprise a fuel tank within a vehicle or a machine. However, the method is not limited to such receiving vessels 13.

The apparatus 10 may be used when implementing the method of transferring a gas shown in FIG. 1. The method may be used to transfer gas from the auxiliary vessel 11 to the receiving vessel 13 of the apparatus 10.

Before gas is transferred using the method of FIG. 1, a process gas having a first temperature is contained in the intermediate vessel 12. The first temperature may be ambient temperature. An auxiliary gas is contained in the auxiliary vessel 11 where the auxiliary gas is of the same type of gas as the process gas. The auxiliary gas may have at least substantially the same pressure as the process gas. The temperature of the auxiliary gas may also be at ambient temperature. The receiving vessel 13 may also contain a gas which is at a lower pressure than the process gas in the intermediate vessel 12 and the auxiliary gas in the auxiliary vessel 11. Alternatively, the receiving vessel 13 may be substantially empty. The gas in the receiving vessel 13 is the same type of gas as the process gas. Before the method of FIG. 1 is implemented, the valves 18, 19 in the apparatus 10 are closed.

The first step 1 of the method comprises expanding the process gas to produce a first volume of the process gas and a second volume of the process gas. The first volume of the process gas has a second temperature that is greater than the first temperature. The second volume of the process gas has a third temperature that is less than the first temperature.

The process gas may be expanded in the apparatus 10 of FIG. 2 by opening the valve 18 on the fluid path 17 connecting the intermediate vessel 12 and the receiving vessel 13. Since the process gas initially contained in the intermediate vessel 12 is at a higher pressure than the gas in the receiving vessel 13, a portion of process gas expands into the receiving vessel 13. This portion of process gas increases in temperature during the first step 1 of the method because it does not expand isobarically into the receiving vessel 13. The process gas which enters the receiving vessel 13 at the start of the first step 1 of the method is compressed as process gas continues to expand into the receiving vessel 13 during the first step 1. This causes an increase in the temperature of the process gas received in the receiving vessel 13. The process gas received in the receiving vessel 13 comprises the first volume of the process gas having the second temperature. At least some of the process gas remains in the intermediate vessel 12 and expands substantially isentropically within the intermediate vessel 12. This expansion leads to a decrease in temperature of the process gas in the intermediate vessel 12. The process gas which remains in the intermediate vessel 12 comprises the second volume of process gas having the third temperature.

During the first step 1 of the method, the temperature of the gas already present in the receiving vessel 13 increases. This is because the process gas which expands into the receiving vessel 13 compresses the gas already present in the receiving vessel 13 increasing its temperature.

The first step 1 of the method ends when the gas in the intermediate vessel 12 and receiving vessel 13 are at substantially the same pressure. The temperature in the intermediate vessel 12 has decreased during the first step 1 of the method and the temperature of the receiving vessel 13 has increased during the first step 1 of the method.

The second step 2 of the method comprises displacing at least some of the second volume of process gas into the receiving vessel 13 using a piston gas. In the apparatus 10 of FIG. 2, the auxiliary gas comprises the piston gas. The second volume of process gas in the apparatus 10 may be displaced from the intermediate vessel 12 by opening the valve 19 on the fluid path 15 connecting the auxiliary vessel 11 and the intermediate vessel 12. The expansion of the process gas in the first method step 1, reduces the pressure in the intermediate vessel 12 to below the pressure in the auxiliary vessel 11. Therefore, the piston gas (i.e. the auxiliary gas) in the auxiliary vessel 11 now has a higher pressure than the second volume of process gas in the intermediate vessel 12. Thus, when the valve 19 is opened piston gas flows along the fluid path 15 connecting the auxiliary vessel 11 and the intermediate vessel 12 and into the intermediate vessel 12. The piston gas acts as a piston, displacing the second volume of process gas from the intermediate vessel 12. That is, the piston gas does work on the second volume of process gas as the piston gas enters the intermediate vessel 12. This causes the temperature of the piston gas which enters the intermediate vessel 12 to increase. The valve 18 on the fluid path 17 connecting the intermediate vessel 12 and the receiving vessel 13 remains open during the second step 2 of the method so that the second volume of process gas which is displaced from the intermediate vessel 12 is received by the receiving vessel 13. As the second volume of process gas enters the receiving vessel 13 its temperature increases because it compresses the gas already present in the receiving vessel 13. However, since at the end of the first step of the method the gas in the intermediate vessel 12 and receiving vessel 13 are at substantially the same pressure, the second volume of process gas enters the receiving vessel 13 substantially isobarically thus the increase in temperature in the receiving vessel 13 is minimised.

The second step 2 of the method ends once a sufficient amount of the second volume of process gas has been displaced into the receiving vessel 13. When this occurs, the valve 18 on the fluid path 17 connecting the intermediate 12 and receiving 13 vessels is closed. The valve 18 may be closed once all or only a portion of the second volume of process gas has been displaced into the receiving vessel. If a portion of the second volume of process gas remains within the intermediate vessel after the valve 18 has closed, this portion of the second volume mixes with the piston gas which entered the intermediate vessel 12. The mixing at least partly counteracts the increase in the temperature of the piston gas that was caused when the piston gas entered the intermediate vessel 12.

During the second step 2 of the method, the piston gas increases the pressure within the intermediate vessel 12. Therefore, at the end of the second step 2 of the method the pressure within the intermediate vessel 12 may be greater than the pressure in the receiving vessel 13. Thus, the method can be repeated to transfer additional gas into the receiving vessel 13. In certain embodiments, the valve 19 on the fluid path 15 between the auxiliary vessel 11 and the intermediate vessel 12 may remain open after the valve 18 on the fluid path connecting the intermediate vessel 12 and the receiving vessel 13 is closed at the end of the second step 2 of the method. Thus, the pressure in the intermediate vessel 12 may be increased further before repeating the first 1 and second 2 method steps. The auxiliary vessel 11 and intermediate vessel 12 may be allowed reached substantially the same pressure before repeating the first 1 and second 2 method steps.

The above described method enables gas to be transferred into a receiving vessel 13, increasing the pressure in the receiving vessel. However, the increase in temperature of the receiving vessel 13 due to this transfer is limited due to the cooling of the second volume of process gas prior to displacing said volume into the receiving vessel 13. At the end of the second step 2 of the method, the first volume of gas with the second temperature and at least some of the second volume of process gas having the third temperature reside in the receiving vessel 13. These gases mix within the receiving vessel 13 so that the final temperature of the process gas within the receiving vessel 13 is less than the second temperature. If substantially all the second volume of process gas is displaced into the receiving vessel 13 the final temperature of the process gas within the receiving vessel 13 may be further reduced. The method therefore enables the temperature of gas within a receiving vessel 13 to be controlled. Additionally, since a gas is used as a piston this reduces the number of moving parts required in the apparatus 10 for transferring gas, thus reducing costs associated with and maintenance of such an apparatus for transferring gas.

In the second step 2 of the method, the piston gas may cause at least some of the second volume of the process gas to substantially flow according to a plug flow regime into the receiving vessel 13. A plug flow regime is one in which there is minimal radial mixing and axial dispersion between two flowing gases i.e. between the piston gas and the second volume of the process gas. Thus, a plug flow regime reduces axial transfer of heat between the piston gas and the second volume of process gas. This is advantageous in that it further limits the temperature increase in the receiving vessel when transferring gas. In the first step 1 of the method, the second volume of process gas was cooled to the third temperature, and as the piston gas displaces the second volume of process gas in the second step 2, the temperature of the piston gas increases. Therefore, it is advantageous to use a plug flow regime in order to limit the heat transfer from the warmer piston gas to the cooler second volume of process gas which enters the receiving vessel 13.

To facilitate the plug flow regime, the method may comprise providing a series of elongate members along which the at least some of the second volume of the first process gas is caused to flow such that radial flow is inhibited. Since the elongate members are narrow relative to their length, radial flow between the piston gas and the second volume of process gas is limited thereby reducing axial transfer of heat between the piston gas and the second volume of process gas. The series of elongate members (not shown) may be incorporated in the apparatus 10 of FIG. 2 within the intermediate vessel 12. Thus, at the end of the first step 1 of the method, at least part of the second volume of process gas may reside within the series of elongate members within the intermediate vessel 12. Then, in the second step 2 of the method, the piston gas expands into the series of elongate members displacing the second volume of process gas from the elongate members.

The series of elongate members may be arranged end-to-end to form a single passage through which gas can flow. Alternatively, the series of elongate members may comprise a bundle of elongate members. That is, the elongate members may be arranged side-by-side so that gas can flow through parallel elongate members. In some embodiments, the series of elongate members may comprise a series of tubular members. When the series of elongate members comprises a bundle of tubular elongate members, gas flows through both the tubular members and spaces formed between the tubular members. In alternative embodiments, each elongate member in the series of elongate members may be shaped such that the elongate members tessellate with one another. For example, all elongate members in the series may have the same shape cross-section and each elongate member in the series may, for example, be a hexagon, quadrilateral, triangle or another tessellating shape in cross-section. This is advantageous when the series of elongate members comprises a bundle because the elongate members provide conduits through which gas can flow which are all the same size. Thus, the pressure across the bundle of elongate members may be substantially uniform.

In certain embodiments, the method may comprise providing one or more floats in the series of elongate members so that in the second step 2 of the method the floats reside between the process gas and the piston gas. The apparatus 10 may comprise one or more floats (not shown) within the series of elongate members. As the piston gas displaces the second volume of process gas, the float moves through the series of elongate members at the boundary between the two gases. Thus, the float reduces mixing between the piston gas and the process gas further improving the plug flow regime. The float may extend across at least part of the cross-section of the series of elongate members to allow gas to pass around the edges of float whilst limiting mixing of the process and piston gases. In embodiments where the series of elongate members comprises a bundle of elongate members, each elongate member in the bundle may comprise a float. In certain embodiments, the float may be a rotameter float. The float may be a sphere, disk or the cross-section of the float may be the same shape as the cross section of the elongate member in which the float resides.

The apparatus 10 may comprise an injector (not shown) at the inlet 14 of the intermediate vessel. The injector injects gas that flows along the fluid path 15 connecting the auxiliary vessel 11 and the intermediate vessel 12 into the intermediate vessel. The injector may be configured to facilitate the plug flow regime of the piston gas by reducing the velocity at which the piston gas enters the intermediate vessel 12. Thus, reducing radial mixing and axial dispersion between the piston gas and the second volume of the process gas. In certain embodiments, the injector may comprise a U-bend so the piston gas entering the intermediate vessel 12 is directed back on itself. The intermediate vessel 12 may additionally or alternatively comprise a plate onto which the piston gas is directed thereby further slowing the velocity of the gas. In certain embodiments, the injector may comprise a conduit which extends into the intermediate vessel 12 from the inlet 14. The piston gas may flow into the intermediate vessel 12 through the conduit. The diameter of the conduit may increase in a direction away from the inlet 14. This increase in diameter causes the velocity of the piston gas to decrease as the gas flows along the conduit facilitating a plug flow regime in the intermediate vessel 12.

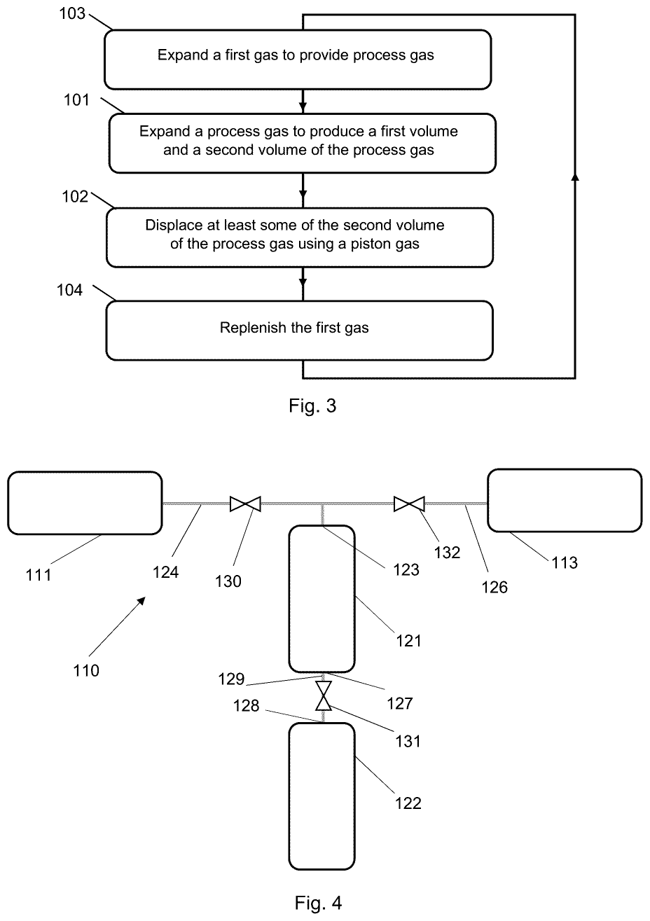

FIG. 3 shows another method for transferring a gas according to another embodiment of the invention. The method of FIG. 3 includes the method steps of FIG. 1 as well as additional steps. FIG. 4 shows an apparatus 110 for transferring a gas according to an embodiment of the invention which may be used to implement the method of FIG. 3. Reference numerals in FIGS. 3 and 4 correspond to those used in FIGS. 1 and 2, respectively, for like steps or features but are transposed by 100.

The apparatus 110 comprises an auxiliary vessel 111, two intermediate vessels and a receiving vessel 113. The two intermediate vessels comprise a first vessel 121 and a second vessel 122. Each vessel in the apparatus 110 is configured to receive and store gas. The first vessel 121 comprises a first opening 123. The auxiliary vessel 111 is selectively fluidly connectable to the first opening 123 of the first vessel 121 such that a fluid path 124 selectively connects the auxiliary vessel 111 and the first vessel 121. The first vessel 121 is selectively fluidly connectable to the auxiliary vessel 111 such that gas may flow from the auxiliary vessel 111 into the first vessel 121 without passing through the second vessel 122. As shown in FIG. 4, the first opening 123 of the first vessel 121 is also selectively fluidly connectable to the receiving vessel 113 such that a fluid path 126 selectively connects the first vessel 121 and receiving vessel 113. In alternative embodiments to the one shown in FIG. 4, the fluid path 124 connecting the auxiliary vessel 111 and the first vessel 121 and the fluid path 126 connecting the first vessel 121 and receiving vessel 113 may each be connectable to a different opening in the first vessel 121.

The first vessel 121 comprises a second opening 127 that is fluidly connected to a corresponding opening 128 in the second vessel 122 so that there is a fluid path 129 selectively connecting the first vessel 121 and the second vessel 122. Along this fluid path 129, gas can flow both from the first vessel 121 to the second vessel 122 and from the second vessel 122 to the first vessel 121. In alternative embodiments, two fluid paths may selectively connect the first and second vessels 121, 122 such that gas may flow from the first vessel 121 to the second vessel 122 along one of the fluid paths and gas may flow from the second vessel 122 to the first vessel 121 along the other fluid path.

The apparatus 110 may comprise one or more valves 130, 131, 132 for controlling gas flow along fluid paths 124, 126, 129. The apparatus 110 may comprise a first valve 130 along the fluid path 124 connecting the auxiliary vessel 111 and the first vessel 121, a second valve 131 along the fluid path 129 connecting the first vessel 121 and the second vessel 122 and a third valve 132 along the fluid path 126 connecting the first vessel 121 and the receiving vessel 112. The valves 130, 131, 132 may comprise needle valves or any other valve suitable of controlling the flow of gas along a fluid path. In alternative embodiments, the first valve 130 and the second valve 131 may be replaced by single valve configured to control the flow of gas between the first vessel 121 and both the auxiliary vessel 111 and the receiving vessel 113.

The apparatus 110 may be configured so that each of the auxiliary vessel 111 and the receiving vessel 113 can be disconnected from one or both of the intermediate vessels 121, 122. Thus, during use, the auxiliary vessel 111 and/or the receiving vessel 113 may be replaceable in the apparatus 110.

The auxiliary vessel 111 may be a high-pressure storage vessel having a large volume compared to the first vessel 121 and the second vessel 122. The first and second vessels 121, 122 may have substantially the same volume as one another. The receiving vessel 113 may have a larger volume than the first vessel 121 and/or the second vessel 122. In certain embodiments, the receiving vessel 113 may comprise a fuel tank within a vehicle or a machine. However, the method is not limited to such receiving vessels 113.

The apparatus 110 of FIG. 4 may be used to implement the method of transferring a gas shown in FIG. 3. Before gas is transferred using the method of FIG. 3 with the apparatus 110, the first vessel 121 contains a first gas and the auxiliary vessel 111 contains an auxiliary gas. The first gas is at a fourth temperature. The auxiliary gas may be at substantially ambient temperature. The auxiliary gas may have at least the same pressure as the first gas. Each of the second vessel 122 and the receiving vessel 113 also contain a gas which is at a lower pressure that the first gas in the first vessel 121. The second vessel 122 and the receiving vessel 113 may have substantially the same pressure. The type of gas in each of the vessels is the same. Before the method of FIG. 3 is implemented, the valves 130, 131, 132 in the apparatus 110 are closed.

The first step 103 of the method comprises expanding the first gas to produce a process gas. This is done by expanding the first gas to provide a first volume of the first gas and a second volume of the first gas. The first gas is expanded in the apparatus 110 by opening the valve 131 on the fluid path 129 connecting the first vessel 121 and the second vessel 122 so that the first gas expands into the second vessel 122. Thus, at the end of the first step 103 of the method, the first volume of the first gas resides in the second vessel 122 and the second volume of the first gas resides in the first vessel 121.

In the same manner as described for the embodiment of FIGS. 1 and 2, the portion of first gas which expands into the second vessel 122 compresses the gas already present in the second vessel 122. Therefore, the temperature of the first gas in the second vessel 122 increases.

The portion of the first gas which expands within the first vessel 121 to form the second volume of first gas expands substantially isentropically which leads to the temperature of the first gas residing in the first vessel 121 decreasing. During the first step 103 of the method, the portion of the first gas in the first vessel 121 decreases from the fourth temperature to a first temperature.

The first step 103 of the method ends when the first and second volumes of process gas are at substantially the same pressure. Thus, the pressure in the second vessel 122 has increased and the pressure in the first vessel 121 has decreased during the first step 103 of the method. At this point, the pressure in both the first vessel 121 and the second vessel 122 is greater than the pressure in the receiving vessel 113. At the end of the first method step 103, the valve 131 between the first vessel 121 and the second vessel 122 is closed.

The second step 101 of the method comprises expanding a process gas to produce a first volume of the process gas and a second volume of the process gas. In the apparatus 110 of FIG. 2, the process gas comprises the cooled second volume of the first gas which resides in the first vessel 121 at the end of the first step 103 of the method. Thus, the second volume of the first gas will hereafter be referred to as the process gas. Therefore, in the second step 101 of the method, the process gas (i.e. the second volume of first gas in the first vessel 121 having the first temperature) is expanded to produce a first volume of the process gas and a second volume of the process gas. The first volume of the process gas has a second temperature that is greater than the first temperature. The second volume of the process gas has a third temperature that is less than the first temperature.

The process gas may be expanded in the apparatus 110 by opening the valve 132 on the fluid path 126 connecting the first vessel 121 and the receiving vessel 113. Since the process gas initially contained in the first vessel 121 is at a higher pressure than the gas in the receiving vessel 113, a portion of process gas expands into the receiving vessel 113. This portion of process gas compresses the gas already present in the receiving vessel 113, increasing the temperature of process gas in the receiving vessel 113. The process gas received in the receiving vessel 113 comprises the first volume of the process gas having the second temperature. At least some of the process gas remains in the first vessel 121 and expands substantially isentropically within the first vessel 121 which leads to a decrease in temperature of the process gas in the intermediate vessel 121. The process gas which remains in the first vessel 121 comprises the second volume of process gas having the third temperature.

The second step 101 of the method ends when the gas in the first vessel 121 and receiving vessel 113 are at substantially the same pressure. The temperature in the first vessel 121 has decreased again during the second step 101 of the method. Since the receiving vessel 113 now contains the first volume of process gas, the temperature of the receiving vessel 113 has increased during the second step 101 of the method.

At the end of the second step 101 of the method, the first and second volumes of process gas are at substantially the same pressure. Thus, the pressure in the first vessel 121 has decreased during the second step 101 and is now lower than the pressure in the second vessel 122. Consequently, the first volume of the first gas residing in the second vessel 122 can act as the piston gas in accordance with the method of FIG. 1. The first volume of the first gas will hereafter be referred to as the piston gas.

The third step 102 of the method comprises displacing at least some of the second volume of process gas into the receiving vessel 113 using the piston gas. The second volume of process gas may be displaced from the first vessel 121 by opening the valve 131 on the fluid path 129 connecting the first vessel 121 and the second vessel 122. The piston gas (i.e. the first volume of the first gas) in the second vessel 122 has a higher pressure than the second volume of process gas in the first vessel 121, and the piston gas flows along the fluid path 129 into the first vessel 121. In the same manner as described for FIG. 1, the piston gas acts as a piston and displaces the second volume of process gas from the first vessel 121. This displacement causes the temperature of the piston gas which enters the first vessel 121 to increase.

During the third step 102 of the method, the valve 132 on the fluid path 126 connecting the first vessel 121 and the receiving vessel 113 remains open so that the second volume of process gas which is displaced from the first vessel 121 is received by the receiving vessel 113. The second volume of process gas enters the receiving vessel 113 substantially isobarically because at the end of the second step 101 of the method the first vessel 121 and receiving vessel 113 are at substantially the same pressure. Thus, the increase in temperature in the receiving vessel 113 caused by the second volume of process gas is minimised.

The third step 102 of the method ends once a sufficient amount of the second volume of process gas has been displaced into the receiving vessel 113. When this occurs, the valve 132 on the fluid path 126 connecting the first vessel 121 and the receiving vessel 113 is closed. The valve 132 may be closed once all or only a portion of the second volume of process gas has been displaced into the receiving vessel 113. If a portion of the second volume of process gas remains within the first vessel 121 after the valve 132 has closed, this portion of the second volume mixes with the piston gas which entered the first vessel 121. The mixing at least partly counteracts the increase in the temperature of the piston gas that was caused when the piston gas entered the first vessel 121.

In the same manner as described above with reference to FIG. 1, in certain embodiments the piston gas may cause at least some of the second volume of the process gas to substantially flow according to a plug flow regime into the receiving vessel 113. Thus, in the same manner as described for the method of FIG. 1, the method FIG. 3 may comprise providing a series of elongate members along which the second volume of process gas may flow and may comprise provide a float in the series of elongate members. Additionally, the first vessel 121 of the apparatus 110 may comprise any of the series of elongate members, the float and the injector in the same manner as the intermediate vessel 12 of FIG. 2.

In a fourth step 104 of the method, the first gas is replenished. In the apparatus 110 of FIG. 1, this is achieved by expanding the auxiliary gas into the first vessel 121 which increases the pressure in the first vessel 121. Auxiliary gas may be expanded into the first vessel 121 by opening the valve 130 between the auxiliary vessel 111 and the first vessel 121 and closing the valve 131 between the first vessel 121 and the second vessel 122. As the auxiliary gas is expanded into the first vessel 121 the temperature in the first vessel 121 increases. The pressure in the first vessel 121 is increased at least until it is greater than the pressure in the second vessel. Then, the method can be repeated to transfer more gas into the receiving vessel 113. Auxiliary gas in the auxiliary vessel 111 may expand into the first vessel 121 until the first vessel 121 and auxiliary vessel 111 are at substantially the same pressure. In the fourth step 104 of the method, the first vessel 121 is effectively re-charged so that the method can be repeated.

The method of FIG. 3 and apparatus of FIG. 4 enables gas to be expanded and cooled twice before being received by the receiving vessel 113. Thus, the method enables gas to be transferred to a receiving vessel 113 whilst limiting the increase of temperature in the receiving vessel 113. Whilst the method of FIG. 3 has been described as starting at the first step 103 using the apparatus 110, the method could start with any of the steps depending upon pressures of gas within the vessels in the apparatus 110.

In certain embodiments, the first vessel 121 of the apparatus 110 may be thermally insulated to further reduce the temperature in the receiving vessel after transferring gas. The insulation (not shown) may be provided within the first vessel 121 so that the first vessel 121 is thermally insulated from gas contained within the first vessel 121. Thus, heat flow between the first vessel 121 and any gas contained within the first vessel 121 may be reduced. Additionally or alternatively, the first vessel 121 may be insulated from its surrounding environment. Thus, heat flow between the first vessel and the surrounding environment may be reduced. In such embodiments, the method of FIG. 3 may additionally comprise storing the second volume of the first gas (i.e. the process gas) in a thermally insulated vessel prior to expanding said gas into the receiving vessel. The thermal insulation then reduces heat flow into the second volume of the first gas so that the decrease in temperature during the first step 103 of the method is maintained.

The method may also comprise storing the second volume of the first gas in a thermally insulated vessel prior to displacing at least some of the second volume of the process gas into the receiving vessel 113 using the piston gas. The thermal insulation then reduces heat flow into the second volume of the process gas so that the decrease in temperature during the second step 101 of the method is maintained.

Providing the insulation within the first vessel 121 so that the first vessel 121 is thermally insulated from gas contained within the first vessel 121 is particularly advantageous when the method of FIG. 3 is repeated multiple times. During the third 102 and fourth 104 method steps, the temperature of gas in the first vessel 121 increases. Without insulation within the first vessel 121, heat would be transferred to the vessel structure during the third 102 and fourth 104 method steps. This heat would then be transferred to the cooled first gas and process gas in the first 103 and second 101 steps of the method, negating some of the cooling caused by expanding the gases. By providing insulation within the first vessel 121, this heat transfer is reduced which helps further limit the increase of temperature in the receiving vessel.

In certain embodiments, the apparatus 110 may comprise a heat exchanger (not shown). The second vessel 122 may be thermally coupled to the heat exchanger. The heat exchanger may be arranged to remove heat from gas contained in the second vessel 122. The heat exchanger may be configured to cool gas contained in the second vessel 122 to ambient air temperature. Thus, as the first volume of the first gas resides in the second vessel 122 during the second step 101 of the method, heat flows through the heat exchanger cooling the first volume of the first gas towards ambient air temperature. This is advantageous because at least some of the first volume of the first gas may be received by the receiving vessel 113 as the method is repeated. The heat exchanger may comprise any heat exchanger capable of cooling to ambient air temperature may be used. For example, the heat exchanger may comprise an air source convective heat exchanger. The heat exchanger may comprise block of metal or a water cooled system both of which comprise means to cool the block or water to ambient air temperature.

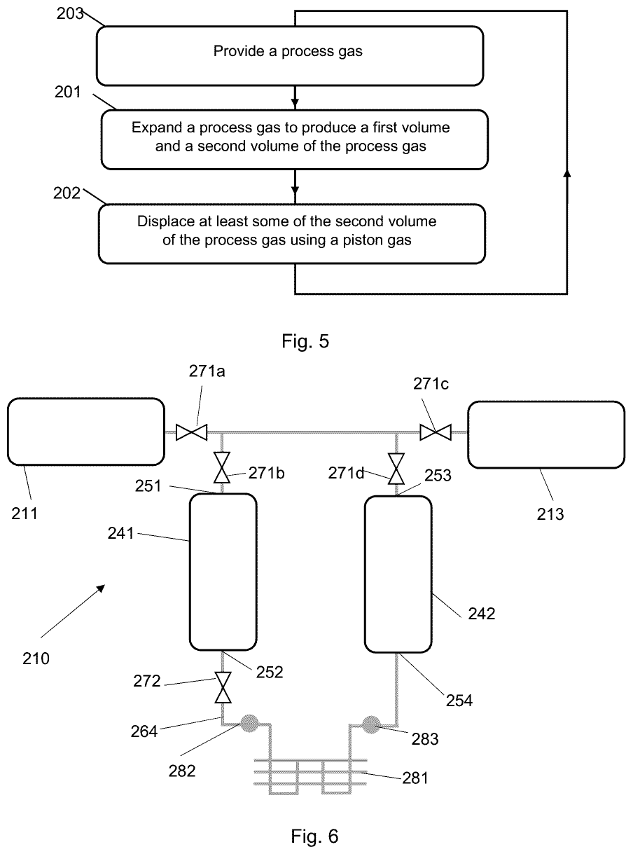

FIG. 5 shows a method for transferring a gas according to another embodiment of the invention. The method of FIG. 5 includes the method step of FIG. 1 as well as additional steps. FIG. 6 shows an apparatus 210 for transferring a gas according to an embodiment of the invention which may be used to implement the method of FIG. 5. Reference numerals in FIGS. 5 and 6 correspond to those used in FIGS. 1 and 2, respectively, for like steps or features but are transposed by 200.

The apparatus 210 comprises an auxiliary vessel 211, intermediate vessels and a receiving vessel 213. The intermediate vessels comprise a first vessel 241 and a second vessel 242. Each vessel 211, 241, 242, 213 is configured to receive and store gas.

The first vessel 241 comprises a first opening 251 and a second opening 252. The auxiliary vessel 211 is selectively fluidly connectable to the first opening 251 of the first vessel 241 such that a fluid path selectively connects the auxiliary vessel 211 and the first vessel 241. The first vessel 241 is selectively fluidly connectable to the auxiliary vessel 211 such that gas may flow from the auxiliary vessel 211 into the first vessel 241 without passing through the second vessel 242. As shown in FIG. 6, the first opening 251 of the first vessel 241 is also selectively fluidly connectable to the receiving vessel 213 such that a fluid path selectively connects the first vessel 241 and receiving vessel 213. In alternative embodiments to the one shown in FIG. 6, the fluid path connecting the auxiliary vessel 211 and the first vessel 241 and the fluid path connecting the first vessel 241 and receiving vessel 213 may each be connectable to a different opening in the first vessel 241. The first opening 251 of the first vessel 241 is fluidly connected to three valves 271a, 271b, 271c to control the flow of gas between the first vessel 241 and the auxiliary vessel 211 and between the first vessel 241 and the receiving vessel 213. In alternative embodiments, the apparatus 210 may comprise one valve to control the flow of gas between the first vessel 241 and both the auxiliary vessel 211 and the receiving vessel 213. The second vessel 242 comprises a first opening 253 and second opening 254. The first opening 253 of the second vessel 242 is fluidly connected to the auxiliary vessel 211 and the receiving vessel 213 in the same manner as the described for the first vessel 241.

The second opening 252 of the first vessel 241 is selectively fluidly connectable to the second opening 254 of the second vessel 242 so that a fluid path 264 selectively connects the second opening 252 of the first vessel 242 to the second opening 254 to the second vessel 242.

The apparatus 210 comprises an intermediate valve 272 on the fluid path 264 connecting the first vessel 241 and the second vessel 242. The intermediate valve 272 controls the flow of gas between second opening 252 of the first vessel 241 and the second opening 254 of the second vessel 242. The intermediate valve 272 may be located anywhere along the fluid path 264 connecting the first vessel 241 and the second vessel 242.

The apparatus 210 comprises a heat exchanger 281. The heat exchanger 281 may comprise any heat exchanger capable of cooling gas to ambient temperature. The heat exchanger 281 is arranged on the fluid path 264 connecting the second opening 252 of the first vessel 241 and the second opening 254 of the second vessel 242. The apparatus 210 comprises a first restriction 282 and a second restriction 283, arranged one on either side of the heat exchanger 281. The first and second restrictions 282, 283 help facilitate a pressure drop between the first and second vessels 241, 242. The first and second restrictions 282, 283 are arranged so that gas flowing along a fluid path 264 from the second opening 252 of the first vessel 241 to the second opening 254 of the second vessel 242 does so via the first and second restrictions 282, 283 and the first heat exchanger 281.

The apparatus 210 may be configured so that each of the auxiliary vessel 211 and the receiving vessel 213 can be disconnected from the intermediate vessels. Thus, during use, the auxiliary vessel 211 and/or the receiving vessel 213 may be replaceable in the apparatus 210. The auxiliary vessel 211 may be a high-pressure storage vessel having a larger volume compared to one or both of the intermediate vessels 241, 242. The receiving vessel 213 may have a larger volume than one or both of the intermediate vessels 241, 242. The receiving vessel 213 may comprise a fuel tank within a vehicle or a machine. However, the method is not limited to such receiving vessels 213.

FIG. 5 shows a method for transferring gas with the apparatus 210 of FIG. 6. The method describes the sequential steps that each one of the intermediate vessels 241, 242 goes through to transfer gas to the receiving vessel 213. The first vessel 241 and the second vessel 242 act in parallel to transfer gas to the receiving vessel 213.

The method of FIG. 5 shows the steps performed in the first vessel 241 of the apparatus 210. However, the steps described apply also to the second vessel 242.

Before the start of the method of FIG. 5, the auxiliary vessel 211 contains an auxiliary gas. The first vessel 241, second vessel 242 and receiving vessel 213 each contain gas at a lower pressure than the auxiliary vessel 211. The gas contained in the second vessel 242 may be at the same pressure as the gas contained in the receiving vessel 213. The gas in all the vessels of the apparatus 210 is the same type of gas. The auxiliary gas and the first gas may be at ambient temperature. All the valves 271a, 271b, 271c, 271d, 272 in the apparatus are closed.

The first step 203 of the method comprises providing a process gas. In the apparatus of FIG. 6, this is done by opening the valves 271a, 271b to open the fluid path between the auxiliary vessel 211 and the first vessel 241. Since the first vessel 241 has a lower pressure than the auxiliary vessel 211, auxiliary gas expands from the auxiliary vessel 211 into the first vessel 241 until the pressure in the auxiliary vessel 211 and the first vessel 241 is substantially the same. At the end of the first step 203, the valves 271a, 271b are used to close the fluid path between the auxiliary vessel 211 and the first vessel 241. The gas now residing in the first vessel 241 has a first temperature. This gas fulfils the same function as the process gas of the method of FIG. 1 and will hereafter be referred to as the process gas.

The second step 201 of the method comprises expanding the process gas (i.e. the gas in the first vessel 241) to produce a first volume of the process gas having a second temperature that is greater than the first temperature and a second volume of the process gas having a third temperature that is less than the first temperature. The process gas is expanded by opening the intermediate valve 272 to provide a fluid path 264 between the first vessel 241 and the second vessel 242. The process gas in the first vessel 241 expands into the second vessel 242 which is at a lower pressure than the first vessel 241. Therefore, at the end of the second step 201 of the method the first volume of the process gas has entered the second vessel 242 and the second volume of the process gas resides in the first vessel 241. In the same manner as described in the other embodiments, the second volume of process gas is cooled when it expands within the first vessel 241. The portion of the process gas which expands into the second vessel 242 flows through the heat exchanger 281 where it is cooled towards ambient temperature prior to entering the second vessel 242. Cooling the gas by the heat exchanger 281 reduces the second temperature. As will be described below, the portion of the process gas which expands into the second vessel 242 displaces gas from the second vessel 242 into the receiving vessel 213.

At the end of the second step 201 of the method, the temperature of the first vessel 241 has decreased. The process gas is expanded in the second step 201 so that the second volume of process gas is at substantially the same pressure as the gas contained in the second vessel 242 and the receiving vessel 213.

The third step 202 of the method comprises displacing at least some of the second volume of process gas from the first vessel 241 into the receiving vessel 213 using a piston gas. In the embodiment of FIGS. 5 and 6, the piston gas is provided from the second vessel 242. After the process gas in the first vessel 241 has been expanded in the second step 201, the intermediate valve 272 is closed and the first step 203 of the method is performed on the second vessel 242 so that the pressure in the second vessel 242 increases to substantially the same pressure at the auxiliary vessel 211. The second vessel 242 then contains a gas at a higher pressure than the second volume of process gas in the first vessel 241. The second volume of process gas in the first vessel 241 can then be displaced into the receiving vessel 213 by opening the intermediate valve 272. Once the intermediate valve 272 is opened, the gas in the second vessel 242 expands into the first vessel 241 where is acts as a piston gas displacing the second volume of process gas in the first vessel 241 into the receiving vessel 213.

The third step of 202 ends when the receiving vessel 213, first vessel 241 and second vessel 242 have reached substantially the same pressure. The first vessel 241 has now returned to substantially the same pressure it was in at the start of the method. Thus, the method can be repeated to transfer more gas into the receiving vessel 213. Whilst the third step 202 of the method is performed in the first vessel 241, the second step 201 of the method is performed in the second vessel 242. Thus, when the first vessel 241 comes to the end of the third step of the method, the second vessel 242 contains a cooled volume of gas ready to be displaced into the receiving vessel 213 when the first vessel 241 next undergoes the second step 201 of the method.

In the method of FIG. 5, each step of the method may end when two or more of the vessels have reached substantially the same pressure. The method therefore simplifies control of gas flow through the apparatus because each method step may end when there is a negligible flow of gas between the vessels. For example, each step in the method may end when the pressures in two or more of the vessels are within 10%, 5%, 2% or less of each other. This range of pressures may help to improve the speed at which gas is transferred to the receiving vessels whilst controlling the temperature in the receiving vessel.

The method of FIG. 5 and apparatus of FIG. 6 helps to control the temperature of gas in the receiving vessel 213 because the expansion of the process gas in the second step of the method cools the gas prior to it being received in the receiving vessel. In the same manner as the above described embodiments, this cooling helps to control the temperature of gas received within the receiving vessel 213. Providing two vessels that work in parallel during the method increases the efficiency of transferring gas to the receiving vessel 213 compared to the method and apparatus 10 of FIGS. 1 and 2. Additionally, the process gas may be expanded until the second volume of process gas has substantially the same pressure as the receiving vessel 213. Therefore, when the second volume of process gas is displaced into the receiving vessel 213, the second volume exits the vessel isobarically. This helps to limit the increase in temperature in the receiving vessel 213 because there is not a pressure drop between the receiving vessel 213 and the vessel supplying it.

In the same manner as described above with reference to FIG. 1, in certain embodiments the piston gas may cause at least some of the second volume of the process gas to substantially flow according to a plug flow regime into the receiving vessel 213. Thus, in the same manner as described for the method of FIG. 1, the method FIG. 5 may comprise providing a series of elongate members along which the second volume of process gas may flow and may comprise provide a float in the series of elongate members. Additionally, the first vessel 241 and second vessel 242 of the apparatus 210 may comprise any of the series of elongate members, the float and the injector in the same manner as the intermediate vessel 12 of FIG. 2.

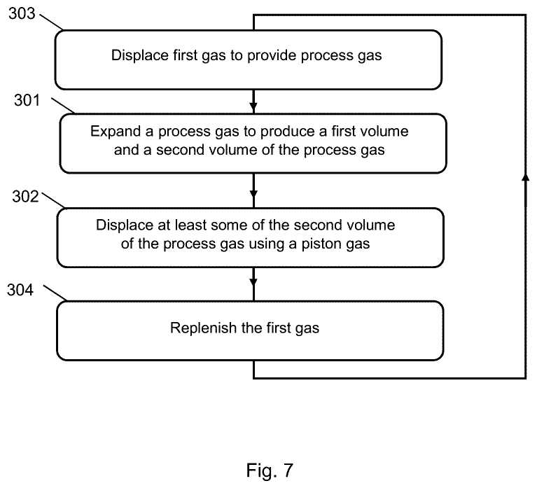

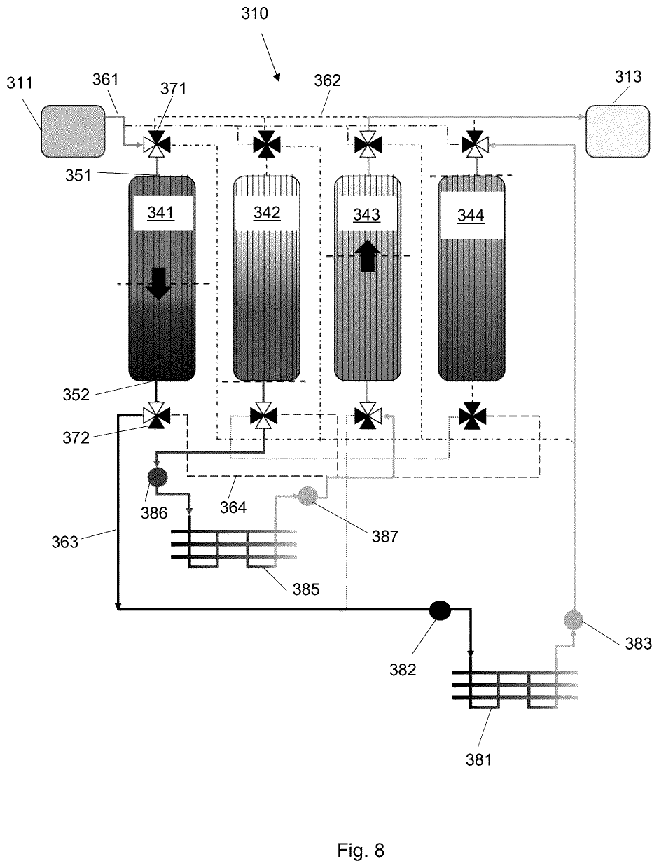

FIG. 7 shows a method for transferring a gas according to another embodiment of the invention. The method of FIG. 7 includes the method step of FIG. 1 as well as additional steps. FIG. 8 shows an apparatus 310 for transferring a gas according to an embodiment of the invention which may be used to implement the method of FIG. 7. Reference numerals in FIGS. 7 and 8 correspond to those used in FIGS. 1 and 2, respectively, for like steps or features but are transposed by 300.

The apparatus 310 comprises an auxiliary vessel 311, intermediate vessels and a receiving vessel 313. The intermediate vessels comprise a first vessel 341, a second vessel 342, a third vessel 343 and a fourth vessel 344. Each vessel 311, 341, 342, 343, 344, 313 is configured to receive and store gas.

The first vessel 341 comprises a first opening 351 and a second opening 352. The auxiliary vessel 311 is selectively fluidly connectable to the first opening 351 of the first vessel 341 such that a fluid path 361 selectively connects the auxiliary vessel 311 and the first vessel 341. The first vessel 341 is selectively fluidly connectable to the auxiliary tank 311 such that gas may flow from the auxiliary vessel 311 into the first vessel 341 without passing through the second vessel 342, the third vessel 343 or the fourth vessel 344. As shown in FIG. 8, the first opening 351 of the first vessel 341 is also selectively fluidly connectable to the receiving vessel 313 such that a fluid path 362 selectively connects the first vessel 341 and receiving vessel 313. In alternative embodiments to the one shown in FIG. 8, the fluid path connecting the auxiliary vessel 311 and the first vessel 341 and the fluid path connecting the first vessel 341 and receiving vessel 313 may each be connectable to a different opening in the first vessel 341. The first opening 351 of the first vessel 341 is fluidly connected to a first valve 371 to control the flow of gas between the first vessel 341 and the auxiliary vessel 311 and between the first vessel 341 and the receiving vessel 313. In alternative embodiments, the apparatus 310 may comprise separate valves that may control the flow of gas between the first vessel 341 and the auxiliary vessel 311 and between the first vessel 341 and the receiving vessel 313. The second vessel 342, third vessel 343 and fourth vessel 344 each comprise a respective first opening and second opening. The first opening of each of the second vessel 342, third vessel 343 and fourth vessel 344 are fluidly connected to the auxiliary vessel 311 and the receiving vessel 313 in the same manner as the described for the first vessel 341.

The second opening 352 of the first vessel 342 is selectively fluidly connectable to the first opening of each of the second vessel 342, the third vessel 343 and the fourth vessel 344 so that a fluid path 363 selectively connects the second opening 352 of the first vessel 342 to the first opening to the second vessel 342, to the first opening to the third vessel 343 and to the first opening to the fourth vessel 344.

The second opening 352 of the first vessel 341 is also selectively fluidly connectable to the second opening of each of the second vessel 342, the third vessel 343 and the fourth vessel 344 so that a fluid path 364 selectively connects the second opening 352 of the first vessel 341 to the second opening to the second vessel 342, to the second opening to the third vessel 343 and to the second opening to the fourth vessel 344.

The second opening 352 of the first vessel 341 is fluidly connected to a second valve 372 to control the flow of gas between second opening 352 of the first vessel 341 and the first opening on another vessel and between the second opening 352 of the first vessel 341 and the second opening of another vessel. In alternative embodiments, the apparatus 310 may comprise separate valves may control the flow of gas between the second opening 352 of the first vessel 341 and the other vessels.

The second openings of the second vessel 342, the third vessel 343 and the fourth vessel 344 are connected to the first openings and second openings of the other vessels in the same manner as described for the first vessel 341.

The apparatus 310 comprises a first heat exchanger 381. The first heat exchanger 381 may comprise any heat exchanger capable of cooling gas to ambient temperature. The first heat exchanger 381 is arranged on the fluid path 363 connecting the second opening 352 of one of the first vessel 341, the second vessel 342, the third vessel 343 and the fourth vessel 344 with the first opening of another vessel. The apparatus 310 comprises two first restrictions 382, 383, arranged one on either side of the first heat exchanger 381. The first restrictions 382, 383 are arranged so that gas flowing along a fluid path from the second opening of one of the first vessel 341, the second vessel 342, the third vessel 343 and the fourth vessel 344 to the first opening of another the first vessel 341, the second vessel 342, the third vessel 343 and the fourth vessel 344 does so via the first restrictions 382, 383 and the first heat exchanger 381.

The apparatus 310 comprises a second heat exchanger 385. The second heat exchanger 385 may comprise any heat exchanger capable of cooling gas to ambient temperature. The second heat exchanger 385 is arranged on the fluid path connecting the second opening of one of the first vessel 341, the second vessel 342, the third vessel 343 and the fourth vessel 344 with the second opening of another of the first vessel 341, the second vessel 342, the third vessel 343 and the fourth vessel 344. The apparatus 310 comprises two second restrictions 386, 387, arranged one on either side of the second heat exchanger 385. The restrictions 386, 387 are arranged so that gas flowing along a fluid path from the second opening of one the first vessel 341, the second vessel 342, the third vessel 343 and the fourth vessel 344 to the second opening of another of the first vessel 341, the second vessel 342, the third vessel 343 and the fourth vessel 344 does so via the restrictions 386, 387 and the second heat exchanger 385.

The apparatus 310 may be configured so that each of the auxiliary vessel 311 and the receiving vessel 313 can be disconnected from one, more than one, or all of the intermediate vessels 341, 342, 343, 344. Thus, during use, the auxiliary vessel 311 and/or the receiving vessel 313 may be replaceable in the apparatus 310. The vessels shown in FIG. 8 are not to scale. The auxiliary vessel 311 may be a high-pressure storage vessel having a larger volume compared to one, more than one, or all of the intermediate vessels 341, 342, 343, 344. The receiving vessel 313 may have a larger volume than one, more than one, or all of the intermediate vessels 341, 342, 343, 344. The receiving vessel 313 may comprise a fuel tank within a vehicle or a machine. However, the method is not limited to such receiving vessels 313.

FIG. 7 shows a method for transferring gas with the apparatus 310 of FIG. 8. The method describes the sequential steps that each one of the intermediate vessels 341, 342, 343, 344 goes through to transfer gas to the receiving vessel 313. At any point during the method, one of the first vessel 341, the second vessel 342, the third vessel 343, the fourth vessel 344 will be subject to one of the steps shown in FIG. 7.

The method of FIG. 7 will be described with reference to the first vessel 341 of the apparatus. However, the steps described apply to the second vessel 342, the third vessel 343 and the fourth vessel 344 as well.

Before the start of the method of FIG. 7, the auxiliary vessel 311 contains an auxiliary gas and the first vessel 341 contains a first gas which has substantially the same pressure as the auxiliary gas in the auxiliary vessel 311. The second vessel 342 contains a gas that has substantially the same pressure as the auxiliary gas in the auxiliary vessel 311. The third vessel 343, the fourth vessel 344 and the receiving vessel 313 each contain gas at a lower pressure than the auxiliary vessel 311 and first vessel 341. The gas in all the vessels of the apparatus 310 is the same type of gas. The auxiliary gas may be at ambient temperature. The first gas may be at or above ambient temperature.

The first step 303 of the method comprises displacing the first gas to provide a process gas. In the apparatus 310 of FIG. 8, the first gas is displaced from the first vessel 342 with the auxiliary gas. This may be done by opening the first valve 371 to open the fluid path 361 between the auxiliary vessel 311 and the first vessel 341 and opening the second valve 372 to provide a fluid path 363 between the second opening 352 first vessel 341 and the first opening of the fourth vessel 344. Since the fourth vessel 344 has a lower pressure than the first vessel 341 and the auxiliary vessel 311, the auxiliary gas enters the first vessel 341 and the first gas is displaced from the first vessel 341 through the second opening 372. Since first gas in the first vessel 341 and the auxiliary gas are at substantially the same pressure, this displacement occurs substantially isobarically. Thus, the temperature in the first vessel 341 at the end first step 303 of the method is substantially the same as the temperature of the auxiliary vessel. That is, the temperature in the first vessel 341 at the end first step 303 of the method may be substantially at ambient temperature. The first gas that is expelled from the first vessel 341 flows through the first heat exchanger 381 where it is cooled towards ambient temperature. The first gas that is expelled from the first vessel 341 is used to perform the fourth step 304 of the method (described below) in the fourth vessel 344.

At the end of the first step 303 of the method, the first gas in the first vessel 341 has been replaced by the auxiliary gas. The first valve 371 is used to close the fluid path 361 between the auxiliary vessel 311 and the first vessel 341 and the second valve 372 is used to close the fluid path 363 between the first vessel 341 and the fourth vessel 344. The auxiliary gas which fills the first vessel 341 at the end of the first step 303 has a first temperature and fulfils the same role as the process gas of the method of FIG. 1. Thus, this gas will hereafter be referred to as the process gas.

The second step 301 of the method comprises expanding the process gas to produce a first volume of the process gas having a second temperature that is greater than the first temperature and a second volume of the process gas having a third temperature that is less than the first temperature. The process gas is expanded by opening the second valve 372 on the second opening 352 of the first vessel 341 to provide a fluid path 364 between the first vessel 341 and the second vessel 342. The process gas in the first vessel 341 expands into the second vessel 342 which is at a lower pressure than the first vessel 341. Therefore, at the end of the second step 301 of the method the first volume of the process gas resides in the second vessel 342 and the second volume of the process gas resides in the first vessel 341. In the same manner as described in the other embodiments, the second volume of process gas is cooled when it expands within the first vessel 341. The portion of the process gas which expands into the second vessel 342 flows through the second heat exchanger 385 where it is cooled towards ambient temperature prior to entering the second vessel 342. As this portion of the process gas expands into the second vessel 342, it is used to perform the third step 302 of the method (described below) in the second vessel 342.

At the end of the second step 301 of the method, the temperature of the first vessel 341 has decreased. The process gas may be expanded in the second step 301 so that the second volume of process gas is at substantially the same pressure as the gas contained in the receiving vessel 313. The second valve 372 is used to close the fluid path 364 between the first vessel 341 and the second vessel 342 at the end of the second step 301.

The third step 302 of the method comprises displacing at least some of the second volume of process gas into the receiving vessel 313 using a piston gas. In the apparatus of FIG. 8, this is done by opening the first valve 371 to open the fluid path 362 between the first vessel 341 and the receiving vessel 313 and opening the second valve 372 to open the fluid path 363 between the first vessel 341 and the fourth vessel 343. As described above, at any point during the method, one of the first vessel 341, the second vessel 342, the third vessel 343, the fourth vessel 344 will be in one of the steps shown in FIG. 7. Whilst the second step 301 of the method was completed in the first vessel 341, the first step of the method was completed in the fourth vessel 343. Thus, the fourth vessel 343 now contains gas at substantially the same pressure as the auxiliary vessel 311. The gas in the fourth vessel 343 provides the piston gas for the first vessel 341. As the first valve 371 and second valve 372 are opened, the piston gas enters the first vessel 341 displacing the cooled second volume of process gas into the receiving vessel 313. Since the second volume of gas in the first vessel 341 is at substantially the same pressure as the receiving vessel 313, the displacement of the second volume of process gas occurs substantially isobarically. Thus, the temperature increase in the receiving vessel 313 is limited as the second volume of process gas enters. The piston gas is cooled prior to entering the first vessel 341 by the second heat exchanger 385 to reduce the final temperature in the first vessel 341 after the piston gas has displaced the second volume of process gas.

The third step of the method ends when the fourth vessel 343, first vessel 341 and receiving vessel 313 have reached substantially the same pressure. At the end of the third step of the method, the first valve 371 is used to close the fluid path 362 between the first vessel 341 and the receiving vessel 313 and the second valve 372 is used to close the fluid path 363 between the first vessel 341 and the fourth vessel 343.

In the same manner as described above with reference to FIG. 1, in certain embodiments the piston gas may cause at least some of the second volume of the process gas to substantially flow according to a plug flow regime into the receiving vessel 313. Thus, in the same manner as described for the method of FIG. 1, the method of FIG. 7 may comprise providing a series of elongate members along which the second volume of process gas may flow and may comprise providing a float in the series of elongate members. Additionally, the first vessel 341, second vessel 342, third vessel 343 and fourth vessel 344 of the apparatus 310 may comprise any of the series of elongate members, the float and the injector in the same manner as the intermediate vessel 12 of FIG. 2.

The fourth step 304 of the method comprises replenishing the first gas. In the apparatus 310 of FIG. 8, this is done by increasing the pressure in the first vessel 341 to substantially the same pressure as the auxiliary vessel 311. This may be done by opening the second valve 372 to open the fluid path 363 between the first vessel 341 and the second vessel 342 so that gas can flow from the second vessel 342 to the first vessel 341. At this point, the second vessel 342 contains gas at substantially the same pressure as the auxiliary vessel 311. As the fourth step 304 of the method is performed in the first vessel 341, the first step 303 of the method is performed in the second vessel 342. The gas that is displaced from the second vessel 342 flows through the first heat exchanger 381 and into the first vessel 341. The first heat exchanger 381 cools the gas prior to it entering the first vessel 341 which help limit the temperature within the first vessel 341 as the incoming gas compresses the gas already present in the first vessel 341. The fourth step 304 of the method ends when the first vessel 341, second vessel 342 and auxiliary vessel 311 have reached substantially the same pressure.

At the end of the fourth step 304 of the method, the first vessel 341 has returned to the initial condition it had prior to the first step 303 of the method. The gas in the first vessel 341 has been re-pressured in the fourth step 304 of the method. Therefore, the method can be repeated to transfer more gas into the receiving vessel 313. Whilst the method is described as starting at the first step 303 in the first vessel 341, the method may be performed in the apparatus 310 starting at any step depending on the initial pressures in the vessels.

During the implementation of the method, one of the intermediate vessels is subject to one of the four method steps at any one time. FIG. 8 shows the first vessel 341 in the first method step 303 and the fourth vessel 344 in the fourth method step 304. Therefore, auxiliary gas is entering the first vessel 341 through its first opening 351 from the auxiliary vessel 311 and gas is being displaced from the first vessel 341 into the fourth vessel 344 via the first heat exchanger 381. As the displaced gas enters the fourth vessel 344 it compresses the gas already in the fourth vessel 344 causing the temperature to rise. Passing the displaced gas through the first heat exchanger 381 helps reduce the temperature in the fourth vessel 344 at the end of the fourth method step 304. Once the auxiliary vessel 311, first vessel 341 and fourth vessel 344 have reached substantially the same pressure there is a negligible flow of gas between the vessels. In FIG. 8, the second vessel 342 is in the second method step 301 and the third vessel 343 is in the third method step 302. Therefore, gas in the third vessel 343 is being displaced into the receiving vessel 313 by gas from the second vessel 342. Once the receiving vessel 313, second vessel 342 and fourth vessel 344 have reached substantially the same pressure there is a negligible flow of gas between the vessels. The method simplifies control of gas flow through the apparatus because each method step may end when there is negligible flow of gas between the vessels. For example, each step in the method may end when the pressures in the auxiliary vessel 311, first vessel 341 and fourth vessel 344 are within 10%, 5%, 2% or less of each other and the pressures in the receiving vessel 313, second vessel 342 and fourth vessel 344 are within 10%, 5%, 2% or less of each other. This range of pressures may help to improve the speed at which gas is transferred to the receiving vessels whilst controlling the temperature in the receiving vessel.

The method of FIG. 7 and apparatus of FIG. 8 help control the temperature of gas in the receiving vessel in several different ways. The expansion of the process gas in the second step of the method cools the gas prior to it being received in the receiving vessel. In the same manner as the above described embodiments, this cooling helps to control the temperature of gas received within the receiving vessel. By including the first 303 and fourth 304 steps in the method, the temperature of the receiving vessel 313 can be further reduced. In the fourth step of the method, the gas in a vessel is re-pressurised which causes the temperature in the vessel to rise. The first step 303 then displaces this warmed gas from the vessel with cooler gas from the auxiliary vessel 311 before performing the second 301 and third method steps 302 in which gas is transferred to the receiving vessel 313. Therefore, the heat produced in the fourth step 304 is not passed to the receiving vessel 313.

### Example 1

The apparatus 310 shown in FIG. 8 may be used to fill a bus tank with hydrogen gas using a series of Manifold Cylinder Pallets (MCPs) as the auxiliary vessel 311. In the example, the bus tank comprises a composite vessel having a liner.

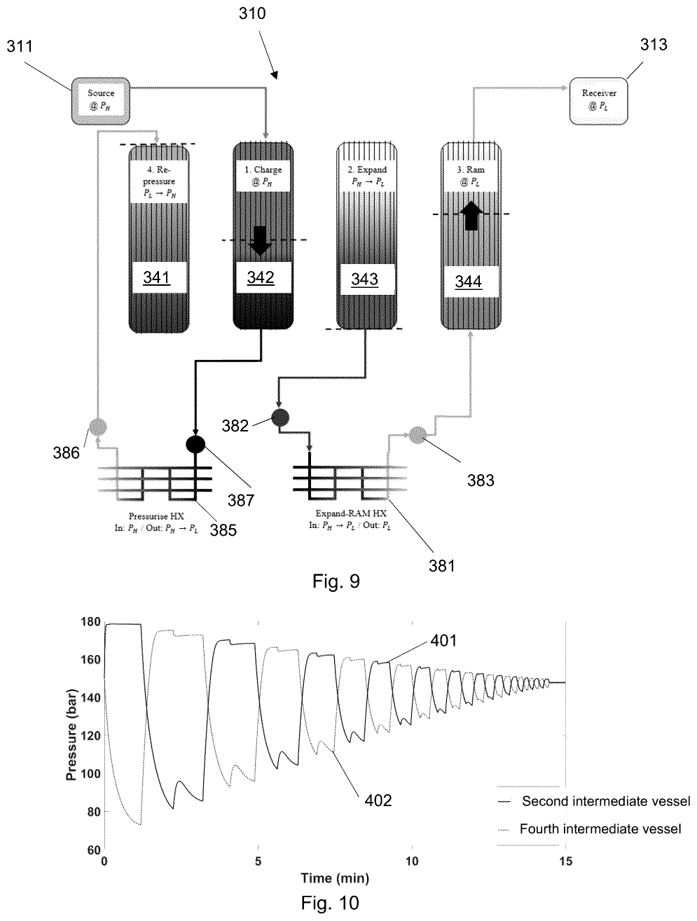

FIG. 9 shows the experiment process diagram for the apparatus 310 of FIG. 8 as it is used to fill a bus tank. In FIG. 9, the receiving vessel 313 is the bus tank which consists of a four 200 litre vessels, at an initial pressure of 60 bar. It is being filled from the auxiliary vessel 311 which includes three MCPs at 180 bar. Each MCP includes nine 80 litre cylinders. The gas from the auxiliary vessel 311 first goes through the four intermediate vessels 341, 342, 343, 344 where it is expanded and cooled before being delivered to the receiving vessel 313. In the embodiment shown in FIG. 9, each of the intermediate vessels 341, 342, 343, 344 comprises a 50 litre double ended cylinder and the first and second heat exchangers 381, 385 are water cooled heat exchangers. The initial pressure of all four intermediate vessels 341, 342, 343, 344 prior to filling a bus tank is 150 bar. The ambient temperature is 10° C.

In the process diagram of FIG. 9, each intermediate vessel is in a different step of the method of FIG. 7. The first intermediate vessel 341 is undergoing the fourth step 304 of the method, the second intermediate vessel 342 is undergoing the first step 303 of the method, the third intermediate vessel 343 is undergoing the second step 301 of the method and the fourth intermediate vessel 344 is undergoing the third step 302 of the method. Each of the intermediate vessels 341, 342, 343, 344 cycles through the method shown in FIG. 7 multiple times to transfer gas from the auxiliary vessel 311 to the receiving vessel 313, that is, the bus tank. FIGS. 10 to 13 show different properties of the apparatus 310 used to transfer gas into the bus tank.

FIG. 10 shows the pressure cycles the second and fourth intermediate vessels 342, 344 experience as the bus tank is filled. The pressure cycle 401 of the second intermediate vessel 342 is shown by the solid line in FIG. 10 and the pressure cycle 402 of the fourth intermediate vessel 344 is shown by the dotted line. The second intermediate vessel 342 is at 150 bar initially and the gas in the vessel is compressed to about 180 bar during the fourth step 304 of the method using gas from the auxiliary vessel 311 and the gas is pushed into the first intermediate vessel 341, pressurising the first intermediate vessel 341 to about 180 bar. Next, the second intermediate vessel 342 goes through second step 301 of the method as the gas expands such that its pressure drops from approximately 180 bar to the pressure of the receiving vessel of approximately 80 bar. Then the second intermediate vessel 342 goes through the third step 302 of the method of FIG. 7. Ideally the third method step 302 should be carried out substantially at a constant pressure, i.e. isobarically. However, the gas may experience an initial pressure increase and then the pressure settles back to the pressure of the receiving vessel. This is due to the dynamic response of the system where the mass flow rate of gas from the first intermediate vessel 341 (that undergoes the second method step when the second intermediate vessel undergoes the third method step) entering second intermediate vessel 342 is higher than the mass flow rate of gas leaving second intermediate vessel 342 resulting in an increase in second intermediate vessel 342 pressure. Finally, the second intermediate vessel 342 is repressurised to the pressure of the source vessel 311 in step four 304 of the method. The fourth intermediate vessels 344 experience a similar sequence of stages however it starts with the third step 302 of the method.

Each of the intermediate vessels 341, 342, 343, 344 repeatedly cycles through the method step shown in FIG. 7 to transfer gas from the auxiliary vessel 311 to the receiving vessel 313, that is, the bus tank.

FIG. 11 shows the mass flow rate delivered to the receiving vessel 313 i.e. the bus tank. The mass flow rate varies between 0.2 kg/min and 0.4 kg/min. The mass flow rate depends on the pressure difference between the receiving vessel 313 and the intermediate vessel going through expansion in the second step 301 of the method. Initially, the pressure difference between the receiving vessel 313 and intermediate vessel undergoing the second step 301 of the method is large and the mass flow rate increases to its maximum of about 0.4 kg/min. As the pressure difference drops so does the mass flow rate. In FIG. 11, when the pressure difference reaches a pre-defined limit of 2 bar, the intermediate vessel which is delivering gas into the receiving vessel 313 is changed so that the receiving vessel 313 receives gas from a different intermediate vessel and the cycle of an increase and subsequent decrease in the mass flow rate begins again. There is also a gradual decrease with time in the mass flow rate peak value for each intermediate vessel. This is because the initial pressure difference between the receiving vessel 313 and the intermediate vessel decreases over time as both the pressure in the auxiliary vessel 311 drops and pressure in the receiving vessel 313 increases.

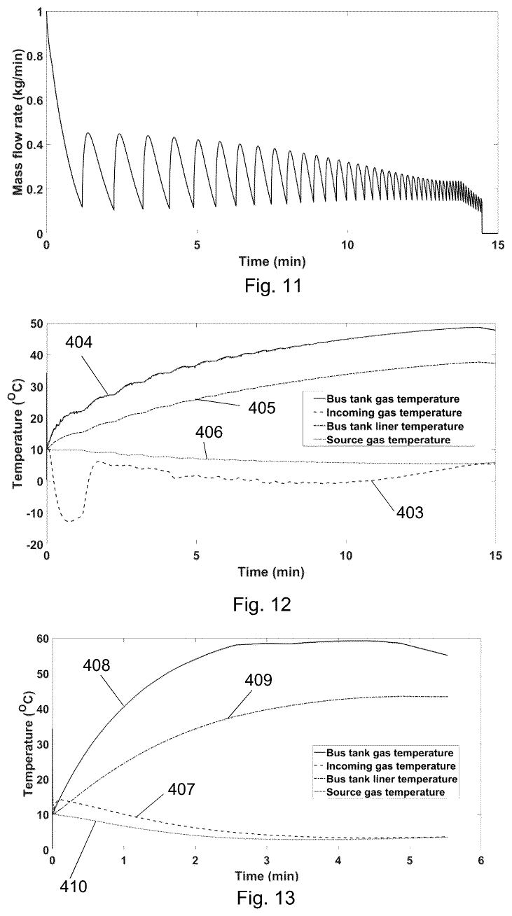

FIG. 12 shows the temperature 403 of gas delivered to the receiving vessel 313 (incoming gas temperature), gas temperature 404 inside the receiving vessel 313 (bus tank temperature), temperature 405 of the liner of the receiving vessel 313 (bus tank liner temperature) and gas temperature 406 inside the auxiliary vessel 311 (source gas temperature) when the apparatus 310 is used to transfer gas from the auxiliary vessel 311 to the receiving vessel 313. During the process, the temperature inside the auxiliary vessel 311 drops slightly as its pressure decreases, i.e. gas expands inside the auxiliary vessel 311. The difference between the temperature 406 of gas inside the auxiliary vessel 311 and the temperature 403 of gas entering the receiving vessel 313 shows that the apparatus 310 is effective at cooling down the gas entering the receiving vessel 313. The temperature reduction depends on the pressure ratio between the auxiliary vessel 311 and the receiving vessel 313. Initially, the apparatus 310 is capable of providing gas at temperatures below −10° C. (i.e. about a 20° C. temperature drop compared to the auxiliary vessel 311) to the receiving vessel 313. This takes place when the fourth intermediate vessel 344 is in the third step 302 of the method of FIG. 7. After this the delivery temperature of gas to the receiving vessel 313 rises to about 5° C. when the third intermediate vessel 343 is in the third step 302 of the method which is still a 5° C. temperature drop compared to the temperature of gas in the auxiliary vessel 311. As shown in FIG. 12, the gas temperature inside the receiving vessel 313 only rises to 50° C. at the end of the process.

FIG. 13 shows a comparative example where the receiving vessel 313 is filled directly from the auxiliary vessel 311 i.e. without the use of the apparatus 310 and its intermediate vessels. FIG. 13 shows the temperature 407 of gas delivered to the receiving vessel 313 (incoming gas temperature), gas temperature 408 inside the receiving vessel 313 (bus tank temperature), temperature 409 of the liner of the receiving vessel 313 (bus tank liner temperature) and gas temperature 410 inside the auxiliary vessel 311 (source gas temperature). In FIG. 13, it can be seen that due to the Joules-Thompson effect, the incoming gas temperature 407 is initially higher than the gas temperature 410 inside the auxiliary vessel 311. Therefore, apparatus 310 eliminates this source of heating compared to a direct filling the receiving vessel 313 from the auxiliary vessel 311. In addition, in FIG. 13 gas temperature 408 inside the receiving vessel 313 rises to 60° C. which is 10° C. higher than the gas temperature 404 inside the receiving vessel 313 when the apparatus 310 is used to transfer the gas. Thus demonstrating that the apparatus 310 may be used to achieve a lower final gas temperature in the receiving vessel 313 compared to filling the receiving vessel 313 directly from the auxiliary vessel 311.

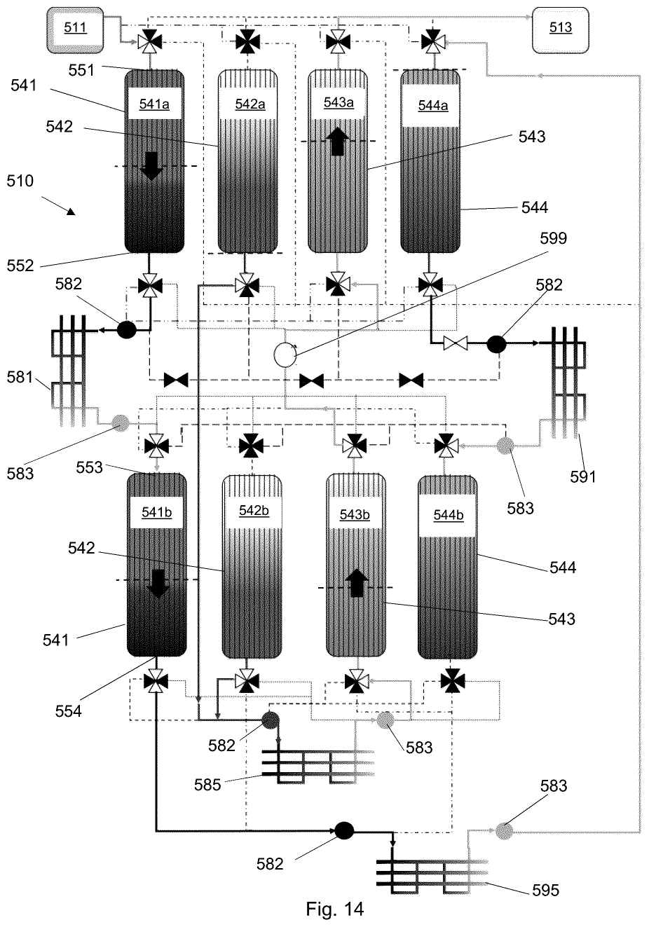

FIG. 14 shows an apparatus 510 for transferring a gas according to an embodiment of the invention. Reference numerals in FIG. 14 corresponds to those used in FIG. 8 for like features but are transposed by 200.

The apparatus 510 comprises an auxiliary vessel 511, intermediate vessels and a receiving vessel 513 The intermediate vessels comprise a first pair of vessels 541, a second pair of vessels 542, a third pair of vessels 543 and a fourth pair of vessels 544. Each pair of vessels comprises a first vessel and a second vessel. Each vessel 511, 541a, 542a, 543a, 544a, 541b, 542b, 543b, 544b, 513 in the apparatus 510 is configured to receive and store gas.

The first vessel 541a of the first pair of vessels 541 comprises a first opening 551 and a second opening 552. The auxiliary vessel 511 is selectively fluidly connectable to the first opening 551 of the first vessel 541a such that a fluid path selectively connects the auxiliary vessel 511 and the first vessel 541a of the first pair of vessels 541. The first vessel 541 is selectively fluidly connectable to the auxiliary tank 511 such that gas may flow from the auxiliary vessel 511 into the first vessel 541 without passing through any other vessel. As shown in FIG. 14, the first opening 551 of the first vessel 541a of the first pair of vessels 541 is also selectively fluidly connectable to the receiving vessel 513 such that a fluid path selectively connects the first vessel 541 and receiving vessel 513. In alternative embodiments to the one shown in FIG. 14, the fluid path connecting the auxiliary vessel 511 and the first vessel 541a and the fluid path connecting the first vessel 541a and receiving vessel 513 may each be connectable to a different opening in the first vessel 541a. The first opening 551 of the first vessel 541a is fluidly connected to a valve to control the flow of gas between the first vessel 541a and the auxiliary vessel 511 and between the first vessel 541a and the receiving vessel 513. In alternative embodiments, the apparatus 510 may comprise separate valves that may control the flow of gas between the first vessel 541a and the auxiliary vessel 511 and between the first vessel 541a and the receiving vessel 513. The first vessels in each of the second pair of vessels 542, the third pair of vessels 543 and the fourth pair of vessels 544 each comprise a respective first opening and second opening. The first opening of the first vessels in each of the second pair of vessels 542, the third pair of vessels 543 and the fourth pair of vessels 544 are fluidly connected to the auxiliary vessel 511 and the receiving vessel 513 in the same manner as the described for the first vessel 541a of the first pair of vessels 541.

The second opening 552 of the first vessel 541a of the first pair of vessels 541 is selectively fluidly connectable to a first opening 553 of the second vessel 541b of the first pair of vessels 541 such that gas may flow from the first vessel 541a into the second vessel 541b. The apparatus 510 comprises a valve configured to control the flow of gas out of the second opening 552 of the first vessel 541a and a valve configured to control the flow of gas into the first opening 553 of the second vessel 541b of the first pair of vessels 541. The second opening 552 of the first vessel 541a of the first pair of vessels 541 is also selectively fluidly connectable to the second opening of the second vessel of each of the second pair of vessels 542, the third pair of vessels 543 and the fourth pair of vessels 544. As such, gas may flow from the first vessel 541a into the second vessel of each of the second pair of vessels 542, the third pair of vessels 543 and the fourth pair of vessels 544 without flowing through the second vessel 541b of the first pair of vessels 541.

A second opening 554 of the second vessel 541b of the first pair of vessels 541 is selectively fluidly connectable to the first opening of the first vessel of each of the second pair of vessels 542, the third pair of vessels 543 and the fourth pair of vessels 544. As such, gas may flow from the second vessel 541b of the first pair of vessels 541 into the first vessel of each of the second pair of vessels 542, the third pair of vessels 543 and the fourth pair of vessels 544. The second opening 554 of the second vessel 541b of the first pair of vessels 541 is also selectively fluidly connectable to the second opening of the second vessel of each of the second pair of vessels 542, the third pair of vessels 543 and the fourth pair of vessels 544. As such, gas may flow from the second vessel 541b of the first pair of vessels 541 into the second vessel of each of the second pair of vessels 542, the third pair of vessels 543 and the fourth pair of vessels 544.

The openings of the first and second vessels in the second pair of vessels 542, the third pair of vessels 543 and the fourth pair of vessels 544 are connected to the first openings and second openings of the other vessels in the same manner as described for the first vessel 541. The apparatus 510 comprises a plurality of valves. Each vessel has a valve positioned adjacent to its first opening and its second opening to control the flow of gas into and out of each vessel.

The apparatus 510 comprises a plurality of first heat exchangers 581, 585, 591, 595. The apparatus 510 is configured so that gas flowing between any of the intermediate vessels may pass through one of the plurality of first heat exchangers 581, 585, 591, 595. For example, gas flowing from the first vessel 541a in the first pair of vessels 541 to the second vessel 541b in the first pair of vessels 541 may pass through one of the plurality of first heat exchangers 581, 585, 591, 595. Additionally, gas flowing from the second vessel 541b of the first pair of vessels 541 to the second vessel 542b in the second pair of vessels 542 may pass through one of the plurality of first heat exchangers 581, 585, 591, 595. Each of the plurality of first heat exchangers 581, 585, 591, 595 may comprise radiator. Each radiator may be configured to cool gas flowing through it to the ambient temperature. In the same manner as described for the apparatus 310 of FIG. 8, the apparatus 510 comprises two first restrictions 582, 583, arranged one on either side of each of the plurality of first heat exchangers 581, 585, 591, 595. In the embodiment shown in FIG. 14, the apparatus comprises four heat exchanges.

As shown in FIG. 14, the apparatus 510 comprises a second heat exchanger 599. The apparatus 510 is configured such that gas flowing from the second vessel of one of the pairs of vessels into the first vessel of that pair of vessels may flow through the second heat exchanger 599. That is, for example, gas flowing from the second vessel 541b of the first pair of vessels 541 into the first vessel 541a of the first pair of vessels 541 may flow through the second heat exchanger 599. The second heat exchanger 599 is configured to extract coolth from gas passing though it. The coolth may then be used to cool gas elsewhere within the apparatus 510, for an alternative purpose or it could be stored for later use. For example, the apparatus 510 may be configured such that coolth extracted by the second heat exchanger 599 may be used to cool auxiliary gas as flows from the auxiliary vessel 511 into one of the pairs of vessels 541, 542, 543, 544.

The apparatus 510 may be configured so that each of the auxiliary vessel 511 and the receiving vessel 513 can be disconnected from one, more than one, or all of the intermediate vessels. Thus, during use, the auxiliary vessel 511 and/or the receiving vessel 513 may be replaceable in the apparatus 510. The vessels shown in FIG. 14 are not to scale. The auxiliary vessel 511 may be a high-pressure storage vessel having a larger volume compared to one, more than one, or all of the intermediate vessels. The receiving vessel 513 may have a larger volume than one, more than one, or all of the intermediate vessels. The receiving vessel 513 may comprise a fuel tank.

The apparatus 510 of FIG. 14 may be used to transfer a gas from the auxiliary vessel 511 to the receiving vessel 513. During the transfer of gas, the intermediate vessels are used in pairs to transfer the gas and each pair of vessels goes through the steps described above for the method of FIG. 7. The method of transferring a gas using the apparatus of FIG. 14 will be described with reference to the first pair of vessels 541 in the apparatus 510. However, the steps described apply to the second pair of vessels 542, the third pair of vessels 543 and the fourth pair of vessels 544 as well.

Before the start of the method, the auxiliary vessel 511 contains an auxiliary gas and the first pair of vessels 541 each contains a gas which has substantially the same pressure as the auxiliary gas in the auxiliary vessel 511. The second pair of vessels 542 contains a gas which is substantially the same pressure as the auxiliary gas in the auxiliary vessel 511. The third pair of vessels 543, the fourth pair of vessels 544 and the receiving vessel 513 each contain gas at a lower pressure than the auxiliary vessel 511 and first pair of vessels 541. The gas in all the vessels of the apparatus 510 is the same type of gas. The auxiliary gas may be at ambient temperature. The first gas may be at or above ambient temperature.

The first step 303 of the method comprises displacing the gas from the first pair of vessels 514. In the apparatus 510 of FIG. 14, the gas is displaced from the first pair of vessels 541 with the auxiliary gas. The valves adjacent to the first and second openings of the each vessel in the first pair of vessel 541 are opened. The auxiliary gas enters the first vessel 541a of the first pair of vessels 541 and displaces the gas from this vessel to provide a process gas in the first vessel 541a. The gas exiting the first vessel 541a passes through one of the plurality of first heat exchangers 581 where is it cooled to ambient temperature before entering the second vessel 541b of the first pair of vessels 541 where it displaces the gas from the second vessel 541b. The gas exiting the second vessel 541b of the first pair of vessels 541 is used to perform the fourth step 304 of the method (described below) in the fourth pair of vessels 344.

At the end of the first step 303 of the method, the gas in the first pair of vessels 541 has been replaced and is at substantially the same pressure at gas in the auxiliary vessel 511. The gas which fills the first vessel 541a of the first pair of vessels 541 at the end of the first step 303 has a first temperature and fulfils the same role as the process gas of the method of FIG. 1. Thus, this gas is referred to as the process gas. The first temperature may be substantial ambient temperature. The second vessel 541b of the first pair of vessels 541 contains a gas having a similar pressure and temperature as the first gas in the first vessel 541a.

The second step 301 of the method comprises expanding the process gas in the first vessel 541a of vessel of the first pair of vessels 541 to produce a first volume of the process gas having a second temperature that is greater than the first temperature and a second volume of the process gas each having a third temperature that is less than the first temperature. The gas within the second vessel 541b of the first pair of vessels 541 is also expanded in a similar manner.

In this step the gas in each of the first vessel 541a and second vessel 541b of the first pair of vessels 541 is expanded into the second vessel 542b of the second pair of vessels 542. Thus, the first vessel 541a of the first pair of vessel 541 is fluidly connected to the second vessel 542b of the second pair of vessels 542 and the second vessel 541b of the first pair of vessel 541 is fluidly connected to the second vessel 542b of the second pair of vessels 542. The process gas in the first vessel 541a and the gas in the second vessel 542b expands into the second vessel 542b of the second pair of vessels 542 which is at a lower pressure than the first pair of vessels 341. In this step the first and second vessels 541a, 541b of the first pair of vessels 541 are not fluidly connected. Thus, gas does not pass between the first and second vessels 541a, 541b of the first pair of vessels 541. Rather, gas flows independently from each of the first and second vessels of the first pair of vessels 541 into the second vessel 542b of the second pair of vessels 542.

At the end of the second step 301 of the method, the second volume of the process gas resides in the first vessel 541a of the first pair of vessels 541. The second vessel 541b of the of the first pair of vessels 541 contains a similar volume of gas. In the same manner as described in the other embodiments, the gas in the first vessel 541a and second vessel 542b of the first pair of vessels 541 is cooled when it expands within the respective vessel. Thus, the gas residing in the first and second vessel 541a, 541b is below ambient temperature at the end of the second step 301. The gas which expands into the second pair of vessels 542 during the second step 310 flows through one of the plurality of first heat exchangers 585 where it is cooled towards ambient temperature prior to entering the second vessel 542b of the second pair of vessels 542. The gas which expands into the second vessel 542b of the second pair of vessels 542, it is used to perform the third step 302 of the method (described below) in the second pair of vessels 542.

At the end of the second step 301 of the method, the temperature of the first pair of vessels 541 has decreased (i.e. each vessel contains a cooled volume of gas) and the pressure of gas in each of the first pair of vessels 541 is at substantially the same pressure as the gas contained in the receiving vessel 513.

The third step 302 of the method comprises displacing at least some of the second volume of process gas into the receiving vessel 513 using a piston gas. That is, the second volume of process gas within the first vessel 541a of the first pair of vessels 541 is displaced into the receiving vessel 513. In the apparatus of FIG. 14, this is done by opening the valve between the first vessel 541a of the first pair of vessels 541 and the receiving vessel 513 and opening the valves to enable gas to flow into the second opening 554 of the second vessel 541b of the first pair of vessels 541 and from the first opening of the second vessel 541b into the second opening of the first vessel 541a. As described above, at any point during the method, one of the first vessel 541, the second vessel 542, the third vessel 543, the fourth vessel 544 will be in one of the steps shown in FIG. 14. Whilst the second step 301 of the method was completed in the first pair of vessels 541, the first step 303 of the method was completed in the fourth pair of vessels 543. Thus, the fourth pair of vessels 543 now contains gas at substantially the same pressure as the auxiliary vessel 511. The gas in the fourth pair of vessels 543 provides the piston gas for the first pair of vessels 541. The piston gas enters the second vessel 541b of the first pair of vessels 541 displacing the cooled volume of gas from the second vessel 541b into the first vessel 541a of the first pair of vessels 541. As this gas enters the first vessel 541a it in turn displaces the cooled second volume of process gas from the first vessel 541a into the receiving vessel 513. The displacement of gas into the receiving vessel 513 occurs substantially isobarically. Thus, the temperature increase in the receiving vessel 513 is limited as the second volumes of process gas enters.

The piston gas is cooled prior to entering the second vessel 541b of the first pair of vessels 541 one of the plurality of first heat exchangers 585, 595 thereby reducing the final temperature in the second vessel 541b of the first pair of vessels 541 after the piston gas has displaced the gas from this vessel.

As the cooled volume of gas from the second vessel 541b is displaced into the first vessel 541a of the first pair of vessels 541 by the piston gas, it passes through the second heat exchanger 599. The second heat exchanger extracts coolth from the cooled volume of gas which may be used to cool gas elsewhere within the apparatus 510 or for an alternative purpose.

The third step 302 of the method ends when the second volume of process gas from the first vessel 541a has been displaced into the receiving vessel 513. At the end of the third step 302 of the method the first vessel 541a is filled with the gas which resided within the second vessel 541b of the first pair of vessels 541 at the end of the second step 301 of the method. Additionally, at the end of the third step of the method the fourth pair of vessels 543, first pair of vessels 541 and receiving vessel 513 are at substantially the same pressure.

In the same manner as described above with reference to FIG. 1, in certain embodiments the piston gas may cause gas within the first pair of vessels 541 to substantially flow according to a plug flow regime into the receiving vessel 513. Thus, in the same manner as described for the method of FIG. 1, the method may comprise providing a series of elongate members along which gas may flow and may comprise providing a float in the series of elongate members. Additionally, the intermediate vessels of the apparatus 510 may comprise any of the series of elongate members, the float and the injector in the same manner as the intermediate vessel 12 of FIG. 2.

The fourth step 304 of the method comprises replenishing the gas in the first pair of vessels 541. In the apparatus 510 of FIG. 14, this is done by increasing the pressure in the first pair of vessels 341 to substantially the same pressure as the auxiliary vessel 511. At this point, the second pair of vessels 542 contains gas at substantially the same pressure as the auxiliary vessel 511. As the fourth step 504 of the method is performed in the first pair of vessels 541, the first step 303 of the method is performed in the second pair of vessels 542. The gas that is displaced from the second opening of the second vessel 542b in the second pair of vessels 542 flows through one of the plurality of first heat exchangers and through the first opening of the first vessel 541a of the first pair of vessels 541. This displaces gas from the first vessel 541a of the first pair of vessels 541 which flows through one of the plurality of first heat exchangers into the second vessel 541b of the first pair of vessels 541. Thus, the pressure is increased in both vessels of the first pair of vessels 541. The heat exchangers cool the gas prior to it entering each of the first pair of vessels 341 which help limit the temperature within the first pair of vessels 541 as the incoming gas compresses the gas already present in the first pair of vessels 541. The fourth step 304 of the method ends when the first pair of vessels 541, second pair of vessels 542 and auxiliary vessel 511 have reached substantially the same pressure.

At the end of the fourth step 304 of the method, the first pair of vessels 541 have returned to their initial condition it had prior to the first step 303 of the method. The gas in the first pair of vessels 541 has been re-pressured in the fourth step 304 of the method. Therefore, the method can be repeated to transfer more gas into the receiving vessel 313. Whilst the method is described as starting at the first step 303 in the first vessel 341, the method may be performed in the apparatus 510 starting at any step depending on the initial pressures in the vessels. During the implementation of the method, one of the pairs of intermediate vessels is subject to one of the four method steps at any one time. Transferring gas using the apparatus 510 of FIG. 14 further improves the efficiency of cooling gas which is transferred from the auxiliary vessel to the receiving vessel and further minimizes the increase in temperature in the receiving vessel 13.

In each of the above described embodiments, the piston gas is of the same type as the process gas. The process gas, the piston gas and any other gas within the vessels of any of the above-described embodiments may each be a compressed gas. The compressed gas may comprise oxygen, nitrogen, argon, helium, hydrogen, compressed natural gas, methane and mixtures thereof. Such mixtures may include, for example, a mixture of oxygen and nitrogen. In certain embodiments, the piston gas and the process gas may each be a fuel gas. A fuel gas may comprise compressed natural gas, hydrogen or any other gas suitable for use as a fuel. Any gas in the receiving vessel at the start of the method is the same type of gas as the process gas.

Various modifications to the above-described embodiments will be apparent to the skilled person.

In the above described embodiments of the method of transferring gas, the efficiency of cooling the process gas during the step of expanding the process gas may be limited by the relative initial pressures of gas in the auxiliary vessel and the receiving vessel. That is, the efficiency may depend on the pressure ratio of gas in the auxiliary vessel to gas in the receiving vessel. If the initial pressure of gas in the auxiliary vessel is too high relative to the initial pressure of gas in the receiving vessel, when the process gas expands to produce the cooler second volume of the process gas, the resulting second volume may overflow from the intermediate vessel in which it expands. In certain embodiments, the gas may overflow into a heat exchanger where it may be warmed to ambient temperature. Thus, the reducing the efficiency of cooling the gas as it is transferred from the auxiliary vessel to the receiving vessel.

The pressure ratio limit is the ratio of the pressure of gas in the auxiliary vessel to the pressure of gas in the receiving vessel above which the second volume of process gas overflows the intermediate vessel. The pressure ratio limit depends on the number of intermediate vessels used to transfer the gas to a receiving vessel and on the type of gas which is transferred. When transferring hydrogen from an auxiliary vessel with an initial pressure of 450 bar and temperature of 15° C., the pressure limit ratio for the apparatus 110 shown in FIG. 4 is approximately 3. That is, for the apparatus 110 shown in FIG. 4, the second volume of process gas may overflow the intermediate vessel 112 when the initial pressure in the auxiliary vessel 111 is three times higher than the initial pressure in the receiving vessel 113. When transferring hydrogen from an auxiliary vessel with an initial pressure of 450 bar and temperature of 15° C., the pressure limit ratio is approximately 3 for the apparatus 210 of FIG. 6 and for the apparatus 310 shown in FIG. 8 and the pressure limit ratio is approximately 1.7 for the apparatus 510 shown in FIG. 14.

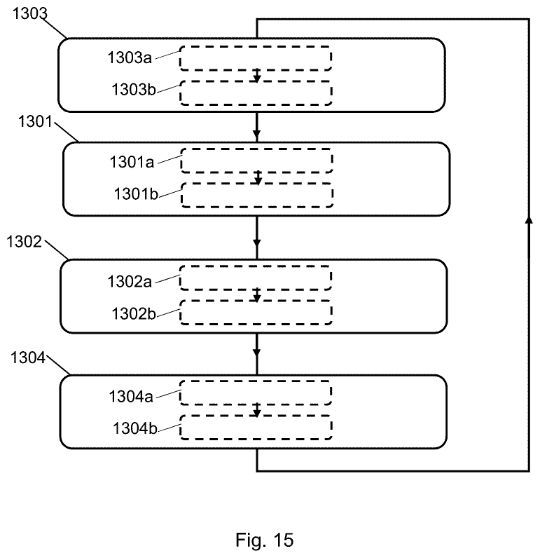

When transferring gas from an auxiliary vessel to a receiving vessel where the pressure ratio is above the pressure ratio limit, the above-described methods may be modified to improve efficiency of cooling the gas during transfer. In certain embodiments, the method shown in FIG. 7 for transferring a gas using the apparatus 310 of FIG. 8 may be modified by splitting each of the method steps into a first period and a second period as shown in FIG. 15. Reference numerals in FIG. 15 correspond to those used in FIG. 7 for like steps but are transposed by 1000. Modifications to the method will be described with reference to the first vessel 341 of the apparatus. However, the steps described apply to the second vessel 342, the third vessel 343 and the fourth vessel 344 as well.

Before the start of the method, the auxiliary vessel 311 contains an auxiliary gas and the first vessel 341 contains a first gas which has substantially the same pressure as the auxiliary gas in the auxiliary vessel 311. The second vessel 342 contains a gas which has substantially the same pressure as the auxiliary gas in the auxiliary vessel 311. The third vessel 343, the fourth vessel 344 and the receiving vessel 313 each contain gas at a lower pressure than the auxiliary vessel 311 and first vessel 341. The gas in all the vessels of the apparatus 310 is the same type of gas. The auxiliary gas may be at ambient temperature. The first gas may be at or above ambient temperature.

The first step of the method 1303 of displacing a first gas to provide a process gas comprises a first period 1303a and a second period 1303b. In the first period 1303a, there is no change to the gas within the first vessel 341. During the second period 1303b, the first gas within the first vessel 342 is displaced to provide a process gas. The first gas is displaced from the first vessel 341 with the auxiliary gas. The first gas that is expelled from the first vessel 341 may enter the fourth vessel 344 where it is used to perform the second period 1304b of fourth step 1304 (described below) in the fourth vessel 344. At the end of the first step 1303 of the method, the first gas in the first vessel 341 has been replaced by the auxiliary gas.

The second step 1301 of the method comprises expanding the process gas to produce a first volume of the process gas having a second temperature that is greater than the first temperature and a second volume of the process gas having a third temperature that is less than the first temperature. The process gas in the first vessel 341 is expanded such that at the end of the second step 1301 the second volume of the process gas resides in the first vessel 341 and the first volume of the process gas resides in two different intermediate vessels. The second step 1301 is divided into a first period 1301a and a second period 1301b, in the first period 1301a and the second period 1303b the destination of the first volume of the process gas which leaves the first vessel 341 differs. In the first period 1301a, a first portion of the first volume of the process gas leaving the first vessel 341 is used to replenish the first gas in the third vessel 343 i.e. to perform the first period 1304a of fourth step 1304 of the method (described below) in the third vessel 343. The first period 1301a may end when the pressure in the first vessel 341 and the third vessel 343 are substantially the same. Alternatively, the first period 1301a may end which the pressure in the first vessel 341 is still greater than the pressure in the third vessel 343. During the second period 1301b of the second step 1301, a second portion of the first volume of the process gas leaving the first vessel 342 is used as the piston gas to displace gas from the second vessel into the receiving vessel 313. That is, to perform the second period 1303b of the third step 1303 (described below) in the second vessel 342. Expanding the process gas in this manner reduces the overflow of the second volume of process gas from the first vessel 341 when it expands thereby improving the efficiency of method for cooling the process gas. Providing two periods in which the process gas leaving the first vessel 341 is delivered to different destinations results in each of the method steps having two periods.

The third step of the method 1302 comprising displacing at least some of the second volume of the process gas using a piston gas is divided into a first period 1302a and a second period 1302b. In the first period 1302a, there is no change to the gas within the first vessel 341. During the second period 1302b, the second volume of process gas is displaced into the receiving vessel 313 using the piston gas. The gas in the fourth vessel 343 provides the piston gas for the first vessel 341. The third step of the method 1303 ends when the fourth vessel 343, first vessel 341 and receiving vessel 313 have reached substantially the same pressure. In the same manner as above described embodiments, the piston gas may cause at least some of the second volume of the process gas to substantially flow according to a plug flow regime into the receiving vessel 313.

The fourth step 1304 of the method comprising replenishing the first gas by increasing the pressure in the first vessel 341 to substantially the same pressure as the auxiliary vessel 311. The fourth step is also divided into a first period 1304a and a second period 1304b. In the first period 1304a of the fourth step, the first gas is replenished using gas exiting the third vessel 343 which is undergoing the first period 1301a of the second step 1301 of expanding the process gas. In the second period 1304b of the fourth step 1304, the first gas is replenished using gas from the second vessel 342 which is undergoing the second period 1303a of the first step 1303. The fourth step 1304 of the method ends when the first vessel 341, second vessel 342 and auxiliary vessel 311 have reached substantially the same pressure.

Dividing each of the method steps into two separate periods improves the efficiency of method for cooling the process gas for the apparatus 310 when the pressures of the auxiliary and receiving vessels are above pressure ratio limit of 3. The modified method of FIG. 15 effectively increased the pressure ration limit of the apparatus 310 to 4.5.

The above-described method of transferring gas using the apparatus 510 of FIG. 14 may be modified in a similar manner to the method for transferring a gas using the apparatus 310 of FIG. 8 in order to improve efficiency of cooling the gas when transferring gas from an auxiliary vessel to a receiving vessel where the pressure ratio is above the pressure ratio limit.

In certain embodiments, the above-described method of transferring gas using the apparatus 510 may be modified by splitting each of the method steps into a first period and a second period as shown in FIG. 15. In such embodiments, in the first period 1303a of the first step of the method 1303 there is no change to the gas within the first pair of vessels 341. During the second period 1303b of the first step of the method 1303, the gas within the first pair of vessels 541 is displaced. The gas that is expelled from the first pair of vessels 541 may enter the fourth pair of vessels 344 where it is used to perform the second period 1304b of fourth step 1304 (described below) in the fourth vessel 344.

In the first period 1301a of the second step 1301 of the method, a first portion of the gas leaving each of the first vessel 514a and the second vessel 541b of the first pair of vessels 541 is used to replenish the third pair of vessels 343. That is, the gas exiting each of the first vessel 514a and the second vessel 541b of the first pair of vessels 541 enters the second vessel 543b of the third pair of vessels 343 to replenish the third pair of vessels 543 i.e. to perform the first period 1304a of fourth step 1304 of the method (described below) in the third pair of vessels 543. The first period 1301a may end when the pressure in the first pair of vessels 541 and the third pair of vessels 543 are substantially the same. Alternatively, the first period 1301a may end which the pressure in the first pair of vessels 541 is still greater than the pressure in the third pair of vessels 543. During the second period 1301b of the second step 1301, a second portion of the gas leaving each of the first vessel 541a and the second vessel 541b of the first pair of vessels 541 is used as the piston gas to displace gas from the second pair of vessels 542 into the receiving vessel 513. That is, gas exiting each of the first vessel 541a and the second vessel 541b of the first pair of vessels 541 enters the second vessel 542b of the second pair of vessels 542 to perform the second period 1303b of the third step 1303 (described below) in the second vessel 342. Expanding the gas in this manner reduces the overflow of the gas from the first pair of vessels 541 when it expands thereby improving the efficiency of method for cooling the process gas. During the second step 1301 of the method, there is no flow of gas between the first vessel 541a and the second vessel 541b of the first pair of vessels 541.

In the first period 1302a of the third step of the method 1302, there is no change to the gas within the first pair of vessels 541. During the second period 1302b of the third step of the method 1302, the gas in each of the first and second vessels 541a, 541b of the first pair of vessels are displaced from the first pair of vessels 541 using the piston gas. The gas in the fourth pair of vessels 544 provides the piston gas for the first pair of vessels 541. That is, gas exiting the second vessel 544b of the fourth pair of vessels 544 enters the second vessel 541b of the first pair of vessels to displace the second volumes of process gas. The third step of the method 1303 ends when the fourth pair of vessels 544, first pair of vessels 541 and receiving vessel 513 have reached substantially the same pressure.

In the first period 1304a of the fourth step 1304 of the method, the first gas in the first pair of vessels is replenished using gas exiting the third pair of vessels 543 which is undergoing the first period 1301a of the second step 1301. That is, gas exiting the second vessel 543b of the third pair of vessels 543 enters the first vessel 541a of the first pair of vessels 541 to replenish the first pair of vessels 541. In the second period 1304b of the fourth step 1304, the gas in the first pair of vessels is replenished using gas from the second pair of vessels 542 which is undergoing the second period 1303a of the first step 1303. Thus, gas exiting the second vessel 542b of the second pair of vessels 542 enters the first vessel 541a of the first pair of vessels 541 to replenish the first pair of vessels 541. The fourth step 1304 of the method ends when the first pair of vessels 541, second pair of vessels 542 and auxiliary vessel 511 have reached substantially the same pressure as one another.

Dividing each of the method steps into two separate periods as shown in FIG. 15 improves the efficiency of method for cooling the process gas for the apparatus 510 when the pressures of the auxiliary and receiving vessels are above pressure ratio limit of 1.7. The modified method of FIG. 15 effectively increased the pressure ration limit of the apparatus 510 to 2.

In each of the above described embodiments, the orientation of the intermediate vessels is not limited to the arrangement shown in the Figures. In the arrangement of intermediate vessels shown in FIGS. 4, 6 and 8, the vessels are orientated such that second volume of process gas exits each intermediate vessel at a first location and piston gas enters the intermediate location at a second location which is lower on the vessel than the first location. Gas from the auxiliary vessel 311 also enters the intermediate vessels at the first location. As such, the intermediate vessels in FIGS. 4, 6 and 8 are orientated such that cooler gas enters and leaves the vessel at a higher location on the vessel than where warmer gas enters and leaves the vessel. For example, when the method shown in FIG. 7 is performed using the apparatus 310 of FIG. 8, gas from the auxiliary vessel 311 enters the first intermediate vessel 341 through the first opening 351 (i.e. the first location) and in the third step 302 of the method gas which has been expanded and cooled during the second step 302 leaves the first intermediate vessel 341 through the first opening 351. As such, gas leaving the first intermediate vessel 341 through the first opening 351 is cooler than gas which leaves the second opening 352 (i.e. the second location) of the first intermediate vessel 341 during the first and second steps of the method 303, 301. In FIG. 7, the first opening 351 is at the top of the first intermediate vessel 341 and the second opening 352 is at the bottom of the first intermediate vessel 341. That is, the first opening 351 is above (i.e. higher than) the second opening 352. It is the same orientation for the second, third and fourth intermediate vessels 342, 343, 344. In alternative embodiments of the apparatus shown in FIGS. 4, 6 and 8, the intermediate vessels may be orientated such that process gas exits each intermediate vessel at the first location and piston gas enters the intermediate location at the second location where the second location is higher on the intermediate vessel than the first location. The first location may be the bottom of the intermediate vessel and the second location may be at the top of the intermediate vessel. Gas from the auxiliary vessel 311 may also enter the intermediate vessel at the first location. For example, the embodiment of apparatus 310 to that shown in FIG. 8 may be modified such that the second opening 352 of the first intermediate vessel 341 is arranged to be above the first opening 351. The second, third and fourth intermediate vessels 342, 343, 344 may be similarly orientated. As such, cooler gas enters and leaves each intermediate cylinder at a lower position on the vessel than warmer gas to the enters or leaves each vessel. This arrangement may improve the separation of warmer gases and cooler gases within each intermediate vessel as the higher temperature gas has a lower density and will rise towards the top of the vessel whereas as cooler gas will have a higher density and will sink towards the bottom of the vessel. Thus, during use of the apparatus this arrangement may improve separation and reducing mixing of the warmer piston gas from the cooler second volume of the process gas thereby helping to reduce the temperature of gas entering the receiving vessel.

In certain embodiments, the relative sizes of the vessels may differ from those in the above described embodiments. In alternative embodiments to the apparatus 110 of FIG. 4, the first and second vessels 121, 122 may have different volumes to one another. For example, the second vessel 122 may be two to three times the size of the first vessel 121.

The apparatus 10 of FIG. 2 may additionally comprise a heat exchanger between the intermediate vessel 12 and the receiving vessel 13 to cool gas before entering the receiving vessel 13. The heat exchanger may comprise any suitable heat exchanger capable of cooling gas towards ambient temperature.

The method shown in FIG. 3 is not limited to beginning with the first step 103. Depending on the pressures in the first vessel 121 and the second vessel 122 the method may begin at a step other than the first step 103. For example, if the first vessel 121 has substantially the same pressure as the second vessel 122, the method may begin at the fourth step 104 to re-charge the first vessel 121.

In certain embodiments, the first 1 and second 2 steps of the method shown in FIG. 1 may occur simultaneously. In such embodiments, the apparatus 10 of FIG. 2 additionally comprises a restriction (not shown) on the fluid path 15 connecting the auxiliary vessel 11 and the intermediate vessel 12. The restriction limits the expansion of the piston gas from the auxiliary vessel 11 into the intermediate vessel 12 so that the process gas can being to expand into the receiving vessel 13 to produce the first and second volumes.

In certain embodiments, the second 101 and third 102 steps of the method shown in FIG. 3 may occur simultaneously. In such embodiments, the apparatus 110 of FIG. 4 additionally comprises a restriction (not shown) on the fluid path 129 connecting the second vessel 122 and the first vessel 121. The restriction limits the expansion of the piston gas from the second vessel 122 into the first vessel 122 so that the process gas can begin to expand into the receiving vessel 113 to produce the first and second volumes.

In certain embodiments, the fluid paths between the first vessel 341, second vessel 342, third vessel 343 and fourth vessel 344 may be different to those shown in the apparatus 310 of FIG. 8, provided the method of FIG. 7 can be performed in the four vessels. For example, each of the first vessel 341, second vessel 342, third vessel 343 and fourth vessel 344 may comprise additional openings which may be used to provide alternative fluid paths between the vessels. The fluid path 363 connecting the second opening 352 of one of the first vessel 341, the second vessel 342, the third vessel 343 and the fourth vessel 344 with the first opening of another vessel via the first heat exchanger 381 may instead selectively connect the second opening 352 of one of the first vessel 341, the second vessel 342, the third vessel 343 and the fourth vessel 344 with the second opening of another vessel via the first heat exchanger 381.

In certain embodiments, the apparatus 310 of FIG. 8 may comprise a different number of heat exchangers and arrangement of fluid paths. The apparatus may comprise a fluid path with a heat exchanger selectively fluidly connecting each pair of the first, second, third and fourth vessels that is used in the method of FIG. 7. The heat exchangers would not all be used at the same time when implementing the method of FIG. 7 in the apparatus. For example, a fluid path with a heat exchanger may selectively fluidly connect the first and second vessels, the first and fourth vessels, the second and third vessels and the third and fourth vessels. In such embodiments, the number of valves in the apparatus may be reduced.

In certain embodiments, the apparatus 210 of FIG. 6 and the apparatus 310 of FIG. 8 may not comprise the above described heat exchangers.

In certain embodiments, a chain may be formed from multiple apparatuses 310 of FIG. 8. Such embodiments may improve the efficiency of controlling the temperature of gas received in the receiving vessel. A chain may be formed by modifying the apparatus 310 of FIG. 8 so that instead of passing gas through the first and second heat exchangers 381, 385, gas passes through a first and a second subsystem. Each subsystem may comprise an apparatus comprising first, second, third and fourth vessels and first and second heat exchangers fluidly connected to each other in the same as those in the embodiment of FIG. 8.

Throughout the specification, “substantially the same” when referring to two or more vessels being at substantially the same pressure may be understood to mean that there is a 10% or less, a 5% or less, or a 2% or less difference in the pressure of the vessels. For example, two vessels may be considered to have substantially the same pressure when the two pressures of the vessels measured in Barg are between 0 and 10%, 0 and 5%, or 0 and 2% of each other. This pressure range may help to optimize the speed at which gas is transferred to the receiving vessels versus efficiency of controlling the temperature in the receiving vessel.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1-30. (canceled)

31. A method of transferring gas, comprising:
expanding a process gas having a first temperature to produce a first volume of the process gas that has a second temperature that is greater than the first temperature, and a second volume of the process gas that has a third temperature that is less than the first temperature; and
displacing at least some of the second volume of the process gas into a receiving vessel using a piston gas, wherein the piston gas is of the same type as the process gas.

32. A method according to claim 31, wherein expanding the process gas comprises expanding a portion of the process gas into the receiving vessel to produce the first volume residing in the receiving vessel.

33. A method according to claim 31, comprising expanding a first gas having a fourth temperature that is greater than the first temperature to produce a first volume of the first gas and a second volume of the first gas that has the first temperature, wherein process gas comprises the first volume of the first gas.

34. A method according to claim 31, comprising storing the second volume of the process gas in a vessel prior to displacing at least some of the second volume of the process gas into the receiving vessel using the piston gas, wherein the vessel is thermally insulated from a surrounding environment or the vessel is thermally insulated from the second volume of the process gas.

35. A method according to claim 31, wherein the second volume of the process gas has substantially the same pressure as the receiving vessel.

36. A method according to claim 31, comprising providing the process gas by displacing a first gas wherein the first gas and the process gas are at substantially the same pressure.

37. A method according to claim 35, wherein the at least some of the first volume of the process gas is cooled prior to it residing in the receiving vessel or a vessel.

38. A method according to claim 37, comprising using a heat exchanger to cool the at least some of the first volume of the process gas prior to it residing in the receiving vessel or the vessel.

39. A method according to claim 31, wherein displacing the at least some of the second volume of the process gas into the receiving vessel using the piston gas comprises using the piston gas to cause the at least some of the second volume of the process gas to substantially flow according to a plug flow regime into the receiving vessel thereby minimising axial transfer of heat between the first and second volumes of process gas.

40. A method according to claim 39, wherein a series of elongate members are provided along which the at least some of the second volume of the process gas is caused to flow such that radial flow is inhibited.

41. A method according to claim 40, wherein a float is provided in the series of elongate members between the process gas and the piston gas.

42. A method according to claim 40, wherein the series of elongate members comprises a bundle of elongate members.

43. A method according to claim 42, wherein the series elongate members comprises a series of elongate members that tessellate with one another.

44. A method according to claim 31, wherein the process gas and the piston gas are each a compressed gas.

45. A method according to claim 44, wherein the compressed gas comprises one of oxygen, nitrogen, argon, helium, hydrogen, compressed natural gas, methane and mixtures thereof.

46. An apparatus for transferring gas to a receiving vessel, the apparatus comprising:
an auxiliary vessel for containing an auxiliary gas;
a first vessel; and
a second vessel selectively fluidly connectable to the first vessel; and;
wherein the first vessel comprises an opening selectively fluidly connectable to a receiving vessel;
wherein the first vessel is selectively fluidly connectable to the auxiliary vessel such that the auxiliary gas may flow from the auxiliary vessel into the first vessel without passing through the second vessel.

47. An apparatus according to claim 46, wherein the first vessel is configured to be thermally insulated from a surrounding environment or from a volume of gas within the first vessel.

48. An apparatus according to claim 46, wherein the second vessel is thermally coupled to a heat exchanger that is arranged to remove heat from a volume of gas when the volume of gas is contained in the second vessel.

49. An apparatus according to claim 46, wherein the second vessel is selectively fluidly connectable to the auxiliary vessel such that the auxiliary gas may flow from the auxiliary vessel into the second vessel without passing through the first vessel and wherein the second vessel comprises an opening selectively fluidly connectable to a receiving vessel.

50. An apparatus according to claim 46, comprising a heat exchanger in a fluid path connecting the first and second vessels.

51. An apparatus according to claim 50, wherein the heat exchanger is configured to cool to gas to ambient air temperature.

52. An apparatus according to claim 49, comprising a third vessel and a fourth vessel;
wherein the third vessel and the fourth vessel each comprise an opening selectively fluidly connectable to the receiving vessel;
wherein the first, second, third and fourth vessels are each selectively fluidly connectable to the auxiliary vessel such that the auxiliary gas may flow from the auxiliary vessel into each of the vessel without passing through another vessel; and
wherein the first and fourth vessels, the second and third vessels and the third and fourth vessels are selectively fluidly connectable coupled to each other.

53. An apparatus according to claim 52, comprising at least one heat exchanger arranged to remove heat from a volume of gas flowing between at least two of the first, the second, the third and the fourth vessels.

54. An apparatus according to claim 53, wherein the at least one heat exchanger is configured to cool the volume of gas to ambient air temperature.

55. An apparatus according to claim 46, comprising a first series of elongate members within the first vessel.

56. An apparatus according to claim 46, comprising a second series of elongate members within the second vessel.

57. An apparatus according to claim 52, comprising a first series of elongate members within the first vessel, a second series of elongate members within the second vessel, a third series of elongate members within the third vessel and a fourth series of elongate members within the fourth vessel.

58. An apparatus according to claim 55, comprising a float movable within each series of elongate members.

59. An apparatus according to claim 55, wherein each series of elongate members comprises a bundle of elongate members.

60. An apparatus according to claim 55, wherein each series elongate members comprises a series of elongate members that tessellate with one another.
